(19) United States
(12) Patent Application Publication
(10) Pub. No.: US 2025/0244559 A1
(43) Pub. Date: Jul. 31, 2025

(54) OPTICAL SYSTEM AND IMAGE PICKUP APPARATUS

(71) Applicant: CANON KABUSHIKI KAISHA, Tokyo (JP)

(72) Inventor: Takeo MORI, Tochigi (JP)

(21) Appl. No.: 19/038,755

(22) Filed: Jan. 28, 2025

(30) Foreign Application Priority Data
Jan. 31, 2024 (JP) 2024-012423
Aug. 1, 2024 (JP) 2024-125583

(51) Int. Cl. G02B 9/12; G02B 13/18

(52) U.S. Cl. CPC G02B 9/12; G02B 13/18

(57) ABSTRACT

An optical system includes, in order from an object side to an image side, a front group having positive refractive power and including at least one lens unit, an intermediate lens unit having positive refractive power, and a rear group having negative refractive power and including at least one lens unit. A distance between adjacent lens units changes during focusing. The intermediate lens unit moves toward the object side during focusing from infinity to a close distance. The front group includes at least two positive lenses and at least one negative lens. The rear group includes at least one aspheric lens having an aspherical surface with a pole at a position separated from an optical axis.

### BACKGROUND

### Technical Field

The disclosure relates to an optical system suitable for imaging.

### Description of Related Art

Japanese Patent Laid-Open No. 2019-148680 discloses, as an optical system that has a large aperture diameter, a reduced size, and high optical performance, and can perform focusing, an optical system that includes, in order from the object side to the image side, a front group having positive refractive power, an aperture stop, and a rear group having positive refractive power.

### SUMMARY

An optical system according to one aspect of the disclosure includes, in order from an object side to an image side, a front group having positive refractive power and including at least one lens unit, an intermediate lens unit having positive refractive power, and a rear group having negative refractive power and including at least one lens unit or a front group having positive refractive power, an intermediate lens unit, and a rear group including at least one lens unit. A distance between adjacent lens units changes during focusing. The intermediate lens unit moves toward the object side during focusing from infinity to a close distance. The front group includes at least two positive lenses and at least one negative lens. The rear group includes at least one aspheric lens having an aspherical surface with a pole at a position separated from an optical axis. An image pickup apparatus having the above optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 illustrates a sectional view of an optical system according to Example 1.

FIG. 2 illustrates longitudinal and lateral aberration diagrams of the optical system according to Example 1 in an in-focus state (on an object) at infinity.

FIG. 3 illustrates a sectional view of an optical system according to Example 2.

FIG. 4 illustrates longitudinal and lateral aberration diagrams of the optical system according to Example 2 in an in-focus state at infinity.

FIG. 5 illustrates a sectional view of an optical system according to Example 3.

FIG. 6 illustrates longitudinal and lateral aberration diagrams of the optical system according to Example 3 in an in-focus state at infinity.

FIG. 7 illustrates a sectional view of an optical system according to Example 4.

FIG. 8 illustrates longitudinal and lateral aberration diagrams of the optical system according to Example 4 in an in-focus state at infinity.

FIG. 9 illustrates a sectional view of an optical system according to Example 5.

FIG. 10 illustrates longitudinal and lateral aberration diagrams of the optical system according to Example 5 in an in-focus state at infinity.

FIG. 11 illustrates a sectional view of an optical system according to Example 6.

FIG. 12 illustrates longitudinal and lateral aberration diagrams of the optical system according to Example 6 in an in-focus state at infinity.

FIG. 13 illustrates a sectional view of an optical system according to Example 7.

FIG. 14 illustrates longitudinal and lateral aberration diagrams of the optical system according to Example 7 in an in-focus state at infinity.

FIG. 15 illustrates a sectional view of an optical system according to Example 8.

FIG. 16 illustrates longitudinal and lateral aberration diagrams of the optical system according to Example 8 in an in-focus state at infinity.

FIG. 17 illustrates a sectional view of an optical system according to Example 9.

FIG. 18 illustrates longitudinal and lateral aberration diagrams of the optical system according to Example 9 in an in-focus state at infinity.

FIG. 19 illustrates a sectional view of an optical system according to Example 10.

FIG. 20 illustrates longitudinal and lateral aberration diagrams of the optical system according to Example 10 in an in-focus state at infinity.

FIG. 21 illustrates an image pickup apparatus having the optical system according to any one of Examples 1 to 10.

### DETAILED DESCRIPTION

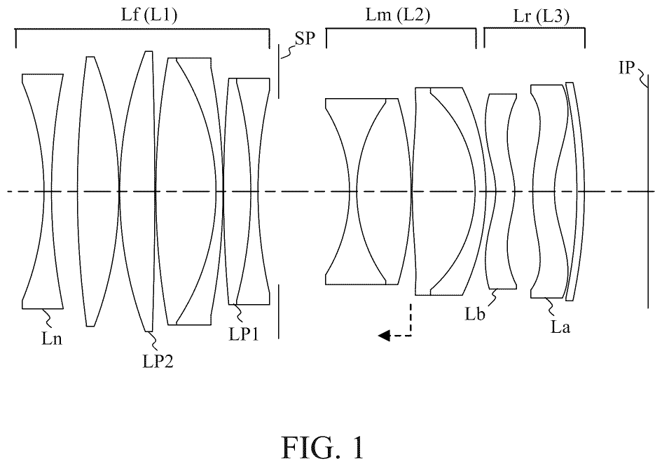

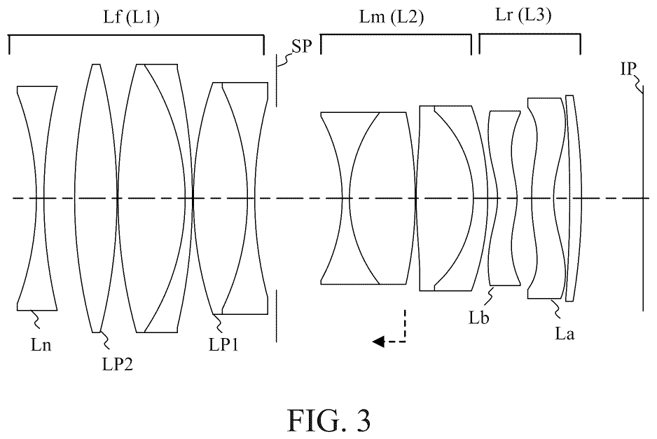

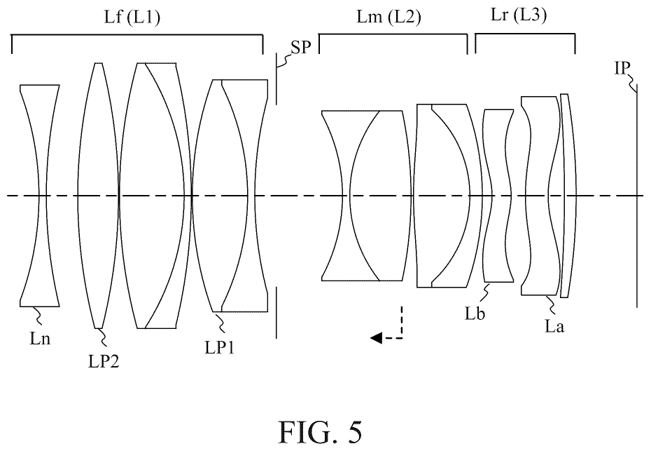

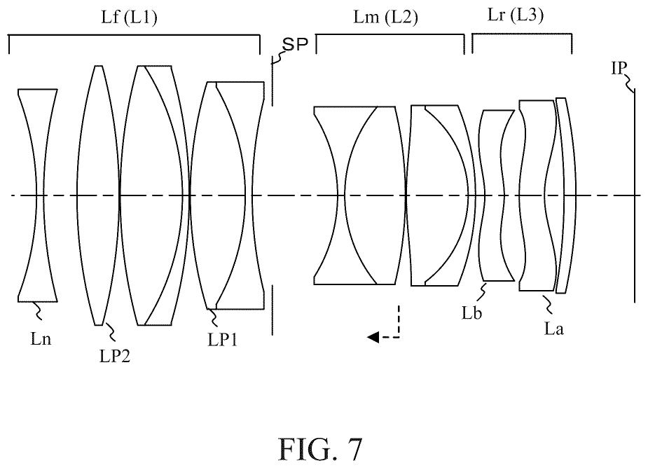

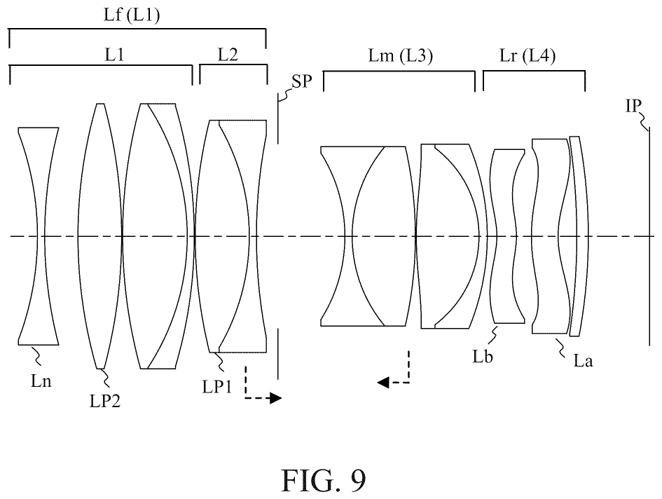

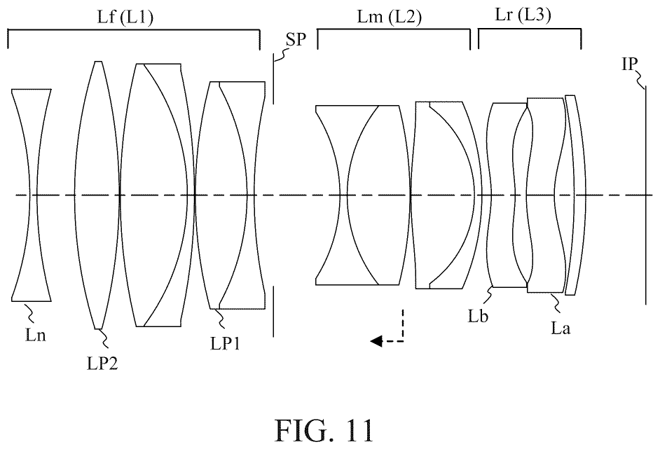

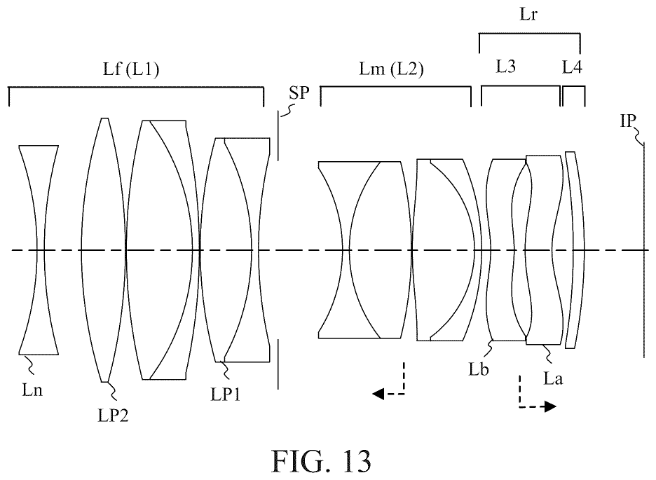

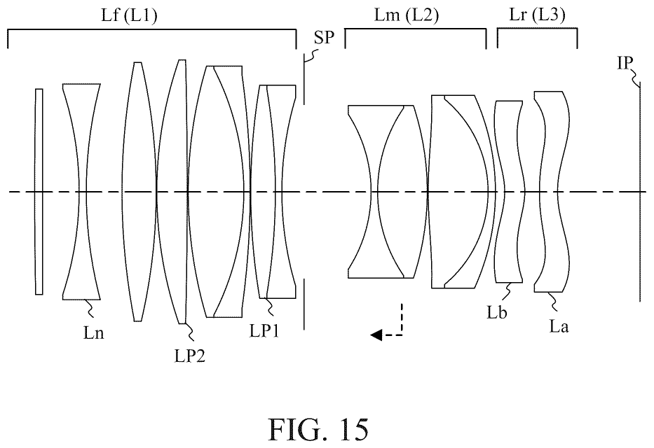

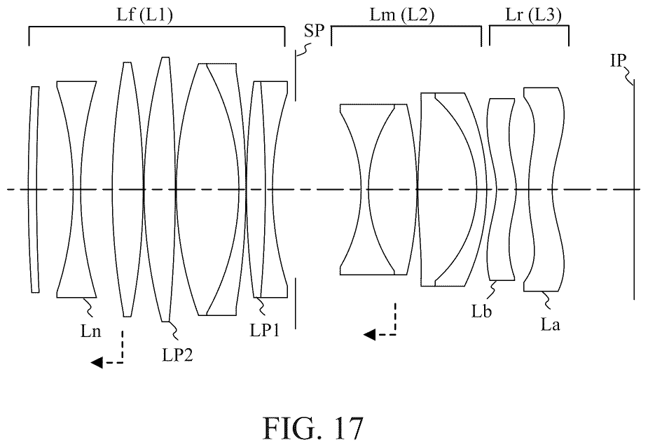

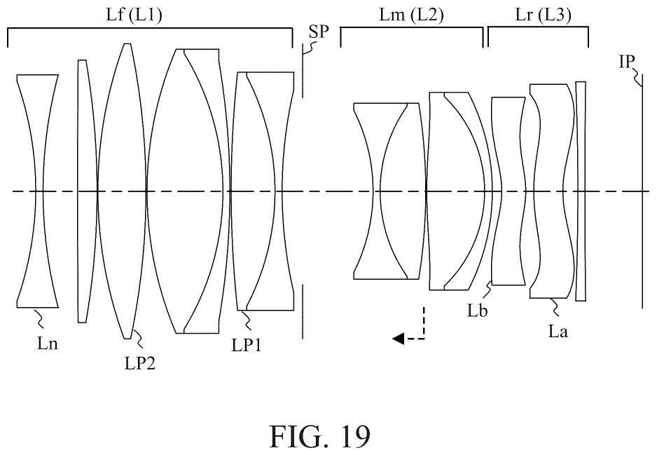

Referring now to the accompanying drawings, a description will be given of examples according to the disclosure. FIGS. 1, 3, 5, 7, 9, 11, 13, 15, 17, and 19 illustrate sections of optical systems according to Examples 1 to 10, respectively. In each figure, a left side is an object side (front side) and a right side is an image side (rear side).

Prior to a detailed description of Examples 1 to 10, a description will now be given of matters common to each example. The optical system according to each example is used for various image pickup apparatuses such as digital video cameras, digital still cameras, broadcasting cameras, film-based cameras, and surveillance cameras.

The optical system according to each example includes a plurality of lens units. These lens units include, in order from the object side to the image side, a front group Lf including at least one lens unit, an intermediate lens unit Lm, and a rear group Lr including at least one lens unit. A lens unit is a group of one or more lenses that integrally move or stand still during focusing. In other words, a distance between adjacent lens units changes during focusing.

Ln represents a negative lens disposed in the front group Lf, and Lp1 and Lp2 represent positive lenses disposed in the front group Lf. SP represents an aperture stop (diaphragm). IP represents a (paraxial) image plane. An imaging surface (light receiving surface) of a solid-state image sensor such as a CCD sensor or a CMOS sensor, or a film surface (photosensitive surface) of a silver film is disposed on the image plane IP.

A glass block having no refractive power, such as a cover glass or an IR cut filter, may be disposed between a lens surface closest to an object of the optical system and the image plane.

In the optical system according to each example, the front group Lf has positive refractive power, the intermediate lens unit Lm has positive refractive power, and the rear group Lr has negative refractive power. Such a telephoto type power arrangement can reduce the overall length of the optical system. The refractive power of each of the lens units and lenses represents refractive power at a paraxial position and corresponds to a reciprocal of a focal length.

In the optical system according to each example, the intermediate lens unit Lm moves toward the object side during focusing from infinity to a close distance. This configuration can converge a light beam at the front group Lf, and thereby reduce the diameter of the light beam incident on the intermediate lens unit Lm and the weight of a focusing mechanism that moves the intermediate lens unit Lm. In each figure, a moving direction of the lens unit during focusing from infinity to a close distance is indicated by a dashed arrow below a lens unit that moves during focusing.

In the optical system according to each example, the front group Lf includes at least two positive lenses Lp1 and Lp2 and at least one negative lens Ln. This configuration can satisfactorily correct chromatic aberration. In a case where two lenses are cemented together to form a cemented lens, the number of lenses is counted as two.

The rear group Lr includes at least one aspheric lens La (Lb) that has an aspherical surface with a pole at a position separated from the optical axis (referred to as periphery hereinafter). This aspheric lens provides a difference in refractive power between a central light beam and a peripheral light beam, thereby satisfactorily correcting sagittal coma flare.

The pole is defined as a point on a lens surface where a tangent plane of the lens surface is perpendicular to the optical axis within the effective diameter.

The optical system according to each example with the above configuration has a reduced size, high optical performance, and a large aperture diameter, and can perform high-speed focusing (autofocus: AF).

In the optical system according to each embodiment, TTL is an overall optical length (referred to as the overall lens length hereinafter), which is a distance on the optical axis from a lens surface closest to the object (the foremost surface) of the optical system to a lens surface closest to the image plane (the final surface) of the optical system plus the back focus. The back focus is an air equivalent length on the optical axis from the final surface of the optical system to the image plane IP. f is a focal length of the optical system, and ω is a half angle of view (°). In this case, the optical system according to each embodiment may satisfy the following inequality (1):

$$3. 0 \leq TTL / ( f \times tan ω ) \leq 10. \qquad ( 1 )$$

Inequality (1) defines a proper relationship between the overall lens length of the optical system and the image height. In a case where TTL/(f×tan ω) becomes higher than the upper limit of inequality (1), the overall lens length increases. In a case where the overall lens length reduces so that TTL/(f×tan ω) becomes lower than the lower limit of inequality (1), the refractive power of each lens increases, and it becomes difficult to correct curvature of field and distortion.

The optical system according to each example may satisfy the following inequality (2):

$$1. 50 \leq PNdave \leq 2. \qquad ( 2 )$$

where PNdave is an average of refractive indices for the d-line (with a wavelength of 587.56 nm) (of the materials) of all the positive lenses included in the optical system.

Inequality (2) defines a proper average refractive index of all positive lenses included in the optical system. In a case where the average refractive index increases such that PNdave becomes higher than the upper limit of inequality (2), the color dispersion increases, and it becomes difficult to correct longitudinal chromatic aberration. In a case where the average refractive index reduces such that PNdave becomes lower than the lower limit of inequality (2), the Petzval sum of the entire system increases, and it becomes difficult to correct curvature of field.

The optical system according to each example may satisfy the following inequality (3):

$$0.01 \leq sk / TTL \leq 0.50 \qquad ( 3 )$$

where sk is the back focus.

Inequality (3) defines a proper relationship between the back focus and the overall lens length. In a case where sk/TTL becomes higher than the upper limit of inequality (3), the overall lens length increases. In a case where the back focus is short such that sk/TTL becomes lower than the lower limit of inequality (3), the effective diameter of the lens disposed on the image side increases, and the size of the optical system increases in the radial direction.

The optical system according to each example may satisfy the following inequality (4):

$$2. \leq ff / sk \leq 10.0 \qquad ( 4 )$$

where ff is a focal length of the front group Lf.

Inequality (4) defines a proper relationship between the focal length of the front group Lf and the back focus. In a case where the refractive power of the front group Lf increases so that ff/sk becomes lower than the lower limit of inequality (4), the Petzval sum of the entire system increases, and it becomes difficult to correct curvature of field and chromatic aberration. In a case where the refractive power of the front group Lf reduces so that ff/sk becomes higher than the upper limit of inequality (4), it shifts from the telephoto type power arrangement and the overall lens length increases.

The optical system according to each example may satisfy the following inequality (5):

$$0.1 \leq - fm / fr \leq 1. \qquad ( 5 )$$

where fm is a focal length of the intermediate lens unit Lm, and fr is a focal length of the rear group Lr.

Inequality (5) defines a proper relationship between the focal length of the intermediate lens unit Lm and the focal length of the rear group Lr. In a case where the refractive power of the rear group Lr reduces so that-fm/fr becomes lower than the lower limit of inequality (5), the lens shifts from the telephoto power arrangement and the overall lens length increases. In a case where the refractive power of the rear group Lr increases so that-fm/fr becomes higher than the upper limit of inequality (5), an incident angle of an off-axis light on an image plane increases, and peripheral light loss called shading becomes remarkable.

The optical system according to each example may satisfy the following inequality (6):

$$0.1 \leq Df / f \leq 1. \qquad ( 6 )$$

where Df is a distance on the optical axis between the front group Lf and the intermediate lens unit Lm.

Inequality (6) defines a proper relationship between a distance between the front group Lf and the intermediate lens unit Lm and the focal length of the optical system. In a case where Df reduces so that Df/f becomes lower than the lower limit of inequality (6), a moving amount of the intermediate lens unit Lm during focusing reduces and short-distance imaging becomes difficult. In a case where Df increases so that Df/f becomes higher than the upper limit of inequality (6), the overall lens length increases.

The optical system according to each example may satisfy the following inequality (7):

$$0.1 \leq - ff / fr \leq 2.0 \qquad ( 7 )$$

Inequality (7) defines a proper relationship between the focal length of the front group Lf and the focal length of the rear group Lr. In a case where the refractive power of the rear group Lr reduces so that-ff/fr becomes lower than the lower limit of inequality (7), the power arrangement separates from the telephoto type and the overall lens length increases. In a case where the refractive power of the rear group Lr increases so that-ff/fr becomes higher than the upper limit of inequality (7), an incident angle of an off-axis light ray on the image plane increases and shading becomes remarkable.

In a case where Lp1 represents a positive lens with the largest Abbe number based on the d-line among all positive lenses included in the front group Lf, the optical system according to each example may satisfy the following inequality (8):

$$55 \leq vdp 1 \leq 97 \qquad ( 8 )$$

where vdp1 is an Abbe number of the positive lens Lp1 based on the d-line.

Inequality (8) defines a proper range of the Abbe number of the positive lens Lp1. In a case where the Abbe number of the positive lens Lp1 reduces so that vdp1 becomes lower than the lower limit of inequality (8), color dispersion increases and it becomes difficult to correct chromatic aberration. In a case where the Abbe number of the positive lens Lp1 increases so that vdp1 becomes higher than the upper limit of inequality (8), no glass materials can be selected.

In a case where Lp2 represents a positive lens with the smallest Abbe number based on the d-line among all positive lenses included in the front group Lf, the optical system according to each example may satisfy the following inequality (9):

$$15 \leq vdp 2 \leq 40 \qquad ( 9 )$$

where vdp2 is an Abbe number of the positive lens Lp2 based on the d-line.

Inequality (9) defines a proper range of the Abbe number of the positive lens Lp2. In a case where the Abbe number of the positive lens Lp2 reduces so that vdp2 becomes lower than the lower limit of inequality (9), no glass materials can be selected. In a case where the Abbe number of the positive lens Lp2 increases so that vdp2 becomes higher than the upper limit of inequality (9), anomalous partial dispersion reduces, and it becomes difficult to correct chromatic aberration on the short wavelength side.

In a case where Ln represents a negative lens disposed closest to an object among all negative lenses included in the front group Lf, the optical system according to each example may satisfy the following inequality (10):

$$15 \leq vdn \leq 40 \qquad ( 10 )$$

where vdn is an Abbe number of the negative lens Ln based on the d-line.

Inequality (10) defines a proper range of the Abbe number of the negative lens Ln. In a case where the Abbe number of the negative lens Ln reduces so that vdn becomes lower than the lower limit of inequality (10), no glass materials can be selected. In a case where the Abbe number of the negative lens Ln increases so that vdn becomes higher than the upper limit of inequality (10), it becomes difficult to correct chromatic aberration.

In the optical system according to each example, the negative lens Ln included in the front group Lf may have a biconcave shape in order to satisfactorily correct spherical aberration.

The optical system according to each example may satisfy the following inequalities (11) in order to satisfactorily correct curvature of field and distortion:

$$0 < Ra 1 / f \qquad ( 11 )$$

$$0 < Ra 2 / f$$

where Ra1 is a paraxial radius of curvature of an object-side lens surface of the aspheric lens La, and Ra2 is a paraxial radius of curvature of an image-side lens surface of the aspheric lens La.

The optical system according to each example may satisfy the following inequality (12) in order to satisfactorily correct curvature of field and chromatic aberration:

$$1. 44 \leq Nda \leq 1.77 \qquad ( 12 )$$

where Nda is a refractive index of the aspheric lens La for the d-line.

The optical system according to each example may include an aspheric lens Lb in the rear group Lr, and satisfy the following inequalities (13) in order to satisfactorily correct curvature of field and distortion:

$$Rb 1 / f < 0$$

$$Rb 2 / f < 0 \qquad ( 13 )$$

where Rb1 is a paraxial radius of curvature of an object-side lens surface of the aspheric lens Lb, and Rb2 is a paraxial radius of curvature of an image-side lens surface of the aspheric lens Lb.

In the optical system according to each example, the aspheric lens Lb may have a pole point in the periphery in order to satisfactorily reduce sagittal coma flare.

Inequalities (1) to (13) may be replaced with inequalities (1a) to (13a) below:

$$4. \leq TTL / ( f \times tan ω ) \leq 7. \qquad ( 1 a )$$

$$1.6 \leq PNdave \leq 1.9 \qquad ( 2 a )$$

$$0.05 \leq sk / TTL \leq 0.3 \qquad ( 3 a )$$

$$3. \leq ff / sk \leq 8. \qquad ( 4 a )$$

$$0.3 \leq - fm / fr \leq 0.7 \qquad ( 5 a )$$

$$0.2 \leq Df / f \leq 0.5 \qquad ( 6 a )$$

$$0.5 \leq - ff / fr \leq 1.5 \qquad ( 7 a )$$

$$60 \leq vdp 1 \leq 96 \qquad ( 8 a )$$

$$16 \leq vdp 2 \leq 30 \qquad ( 9 a )$$

$$18 \leq vdn \leq 30 \qquad ( 10 a )$$

$$0.5 \leq Ra 1 / f \leq 10. \qquad ( 11 a )$$

$$0.2 \leq Ra 2 / f \leq 10.$$

$$1.5 \leq Nda \leq 1.728 \qquad ( 12 a )$$

$$- 10. \leq Rb 1 / f \leq - 0.1 \qquad ( 13 a )$$

$$- 10. \leq Rb 2 / f \leq - 0.1$$

Inequalities (1) to (13) may be replaced with inequalities (1b) to (13b) below:

$$5. \leq TTL / ( f \times tan ω ) \leq 6. \qquad ( 1 b )$$

$$1.7 \leq PNdave \leq 1.85 \qquad ( 2 b )$$

$$0.09 \leq sk / TTL \leq 0.15 \qquad ( 3 b )$$

$$4. \leq ff / sk \leq 7. \qquad ( 4 b )$$

$$0.4 \leq - fm / fr \leq 0.6 \qquad ( 5 b )$$

$$0.3 \leq Df / f \leq 0.4 \qquad ( 6 b )$$

$$0.7 \leq - ff / fr \leq 1. \qquad ( 7 b )$$

$$65 \leq vdp 1 \leq 95 \qquad ( 8 b )$$

$$17 \leq vdp 2 \leq 25 \qquad ( 9 b )$$

$$20 \leq vdn \leq 28 \qquad ( 10 b )$$

$$0.8 \leq Ra 1 / f \leq 2. \qquad ( 11 b )$$

$$0.4 \leq Ra 2 / f \leq 0.5$$

$$1.55 \leq Nda \leq 1.7 \qquad ( 12 b )$$

$$- 1. \leq Rb 1 / f \leq - 0.2 \qquad ( 13 b )$$

$$- 1. \leq Rb 2 / f \leq - 0.2$$

The optical systems according to Examples 1 to 10 will now be described in detail.

In the optical system according to Example 1, the front group Lf includes a first lens unit L1. The first lens unit L1 includes, in order from the object side to the image side, a biconcave negative lens Ln, a positive lens, a positive lens LP2, a cemented lens of a positive lens and a negative lens, and a cemented lens of a positive lens LP1 and a negative lens. An aperture stop SP is disposed between the first lens unit L1 and the second lens unit L2 serving as an intermediate lens unit Lm.

The second lens unit L2 includes, in order from the object side to the image side, a cemented lens of a negative lens and a positive lens, and a cemented lens of a positive lens and a negative lens. The rear group Lr includes a third lens unit L3. The third lens unit L3 includes, in order from the object side to the image side, an aspheric lens Lb, an aspheric lens La, and a positive lens.

In the optical systems according to Examples 2, 3, 4, and 6, the front group Lf includes a first lens unit L1. The first lens unit L1 includes, in order from the object side to the image side, a biconcave negative lens Ln, a positive lens LP2, a cemented lens of a positive lens and a negative lens, and a cemented lens of the positive lens LP1 and a negative lens. An aperture stop SP is disposed between the first lens unit L1 and the second lens unit L2 serving as an intermediate lens unit Lm.

The second lens unit L2 includes, in order from the object side to the image side, a cemented lens of a negative lens and a positive lens, and a cemented lens of a positive lens and a negative lens. The rear group Lr includes a third lens unit L3. The third lens unit L3 includes, in order from the object side to the image side, an aspheric lens Lb, an aspheric lens La, and a positive lens.

In the optical system according to Example 5, the front group Lf includes a first lens unit L1 and a second lens unit L2. The first lens unit L1 includes, in order from the object side to the image side, a biconcave negative lens Ln, a positive lens LP2, and a cemented lens of a positive lens and a negative lens. The second lens unit L2 includes a cemented lens of a positive lens LP1 and a negative lens. The second lens unit L2 moves toward the image side during focusing from infinity to a close distance. An aperture stop SP is disposed between the second lens unit L2 and the third lens unit L3 as the intermediate lens unit Lm.

In the optical system according to Example 5, the front group Lf includes a first lens unit L1 and a second lens unit L2. The first lens unit L1 includes, in order from the object side to the image side, a biconcave negative lens Ln, a positive lens LP2, and a cemented lens of a positive lens and a negative lens. The second lens unit L2 includes a cemented lens of a positive lens LP1 and a negative lens. An aperture stop SP is disposed between the second lens unit L2 and the third lens unit L3 as the intermediate lens unit Lm.

The third lens unit L3 includes, in order from the object side to the image side, a cemented lens of a negative lens and a positive lens, and a cemented lens of a positive lens and a negative lens. The rear group Lr includes a fourth lens unit L4. The fourth lens unit L4 includes, in order from the object side to the image side, an aspheric lens Lb, an aspheric lens La, and a positive lens.

In the optical system according to Example 7, the front group Lf includes a first lens unit L1. The first lens unit L1 includes, in order from the object side to the image side, a biconcave negative lens Ln, a positive lens LP2, a cemented lens of a positive lens and a negative lens, and a cemented lens of a positive lens LP1 and a negative lens. An aperture stop SP is disposed between the first lens unit L1 and the second lens unit L2 serving as the intermediate lens unit Lm.

The second lens unit L2 includes, in order from the object side to the image side, a cemented lens of a negative lens and a positive lens, and a cemented lens of a positive lens and a negative lens. The rear group Lr includes a third lens unit L3 and a fourth lens unit L4. The third lens unit L3 includes, in order from the object side to the image side, an aspheric lens Lb and an aspheric lens La. The third lens unit L3 moves to the image side during focusing from infinity to a close distance. The fourth lens unit L4 includes a positive lens.

In the optical systems according to Examples 8 and 9, the front group Lf includes a first lens unit L1. The first lens unit L1 includes, in order from the object side to the image side, a positive lens, a biconcave negative lens Ln, a positive lens, a positive lens LP2, a cemented lens of a positive lens and a negative lens, and a cemented lens of a positive lens LP1 and a negative lens. An aperture stop SP is disposed between the first lens unit L1 and the second lens unit L2 serving as the intermediate lens unit Lm.

The second lens unit L2 includes, in order from the object side to the image side, a cemented lens of a negative lens and a positive lens and a cemented lens of a positive lens and a negative lens. The rear group Lr includes a third lens unit L3. The third lens unit L3 includes, in order from the object side to the image side, an aspheric lens Lb and an aspheric lens La.

In the optical system according to Example 10, the front group Lf includes a first lens unit L1. The first lens unit L1 includes, in order from the object side to the image side, a biconcave negative lens Ln, a positive lens, a positive lens LP2, a cemented lens of a positive lens and a negative lens, and a cemented lens of the positive lens LP1 and a negative lens. An aperture stop SP is disposed between the first lens unit L1 and the second lens unit L2 serving as the intermediate lens unit Lm.

The second lens unit L2 includes, in order from the object side to the image side, a cemented lens of a negative lens and a positive lens, and a cemented lens of a positive lens and a negative lens. The rear group Lr includes a third lens unit L3. The third lens unit L3 includes, in order from the object side to the image side, an aspheric lens Lb, an aspheric lens La, and a negative lens.

In Examples 1 to 10, each of the front group and the intermediate lens unit has positive refractive power, and the rear group has negative refractive power, but the front group may have negative refractive power, or the intermediate lens unit may have negative refractive power. The rear group may have positive refractive power. In other words, the combination of positive and negative refractive powers among the front group, intermediate group, and rear group is not limited. In Examples 1 to 10, the intermediate lens unit moves toward the object side during focusing from infinity to a close distance, but it may move toward the image side. In other words, a moving direction of the intermediate lens unit is not limited. The front group may include at least two positive lenses and at least two negative lenses. In these cases, at least one of inequalities (1) to (13) may be satisfied.

A description will now be given of numerical examples 1 to 10 corresponding to Examples 1 to 10, respectively. In surface data of each example, a surface number m indicates the order of a surface counted from the object side. r represents a radius of curvature (mm) of an m-th surface, and d (mm) represents a distance on the optical axis between m-th and (m+1)-th surfaces. nd represents a refractive index for the d-line of the optical material between m-th and (m+1)-th surfaces, and vd represents an Abbe number based on the d-line of the optical material. The Abbe number vd based on the d-line is expressed as follows:

$$vd = ( Nd - 1 ) / ( NF - NC )$$

where Nd, NF, and NC are the refractive indices for the d-line, F-line (with a wavelength of 486.13 nm), and C-line (with a wavelength of 656.27 nm) in the Fraunhofer line. An effective diameter (mm) indicates a diameter of an area through which light rays that contribute to imaging on the optical surface pass.

In each numerical example, a focal length (mm), F-number, and half angle of view (°) are all values in a case where the optical system is in focus on an object at infinity. BK and an overall lens length correspond to the back focus sk and overall optical length TTL, respectively.

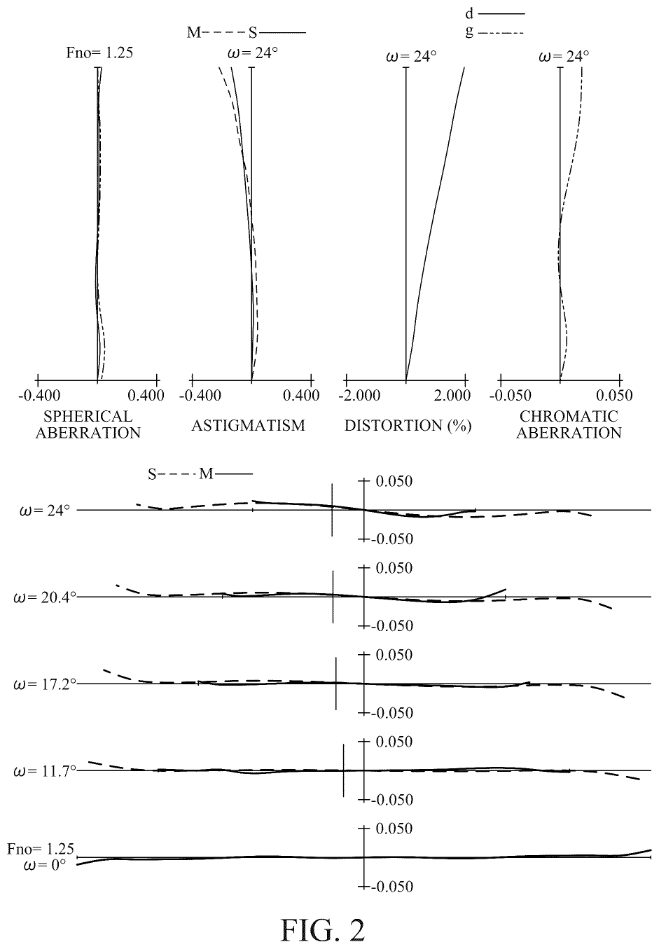

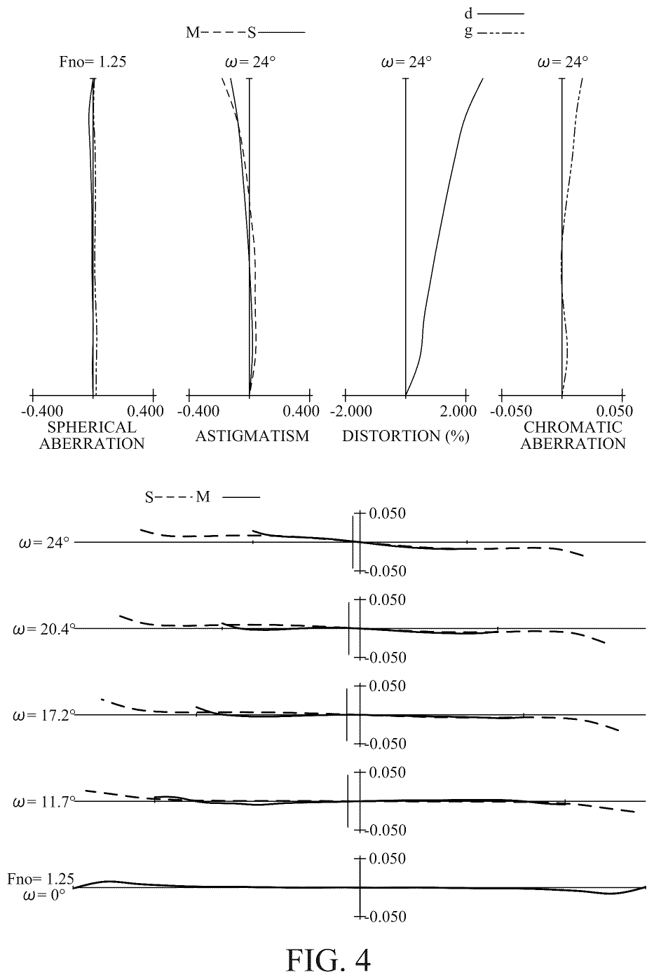

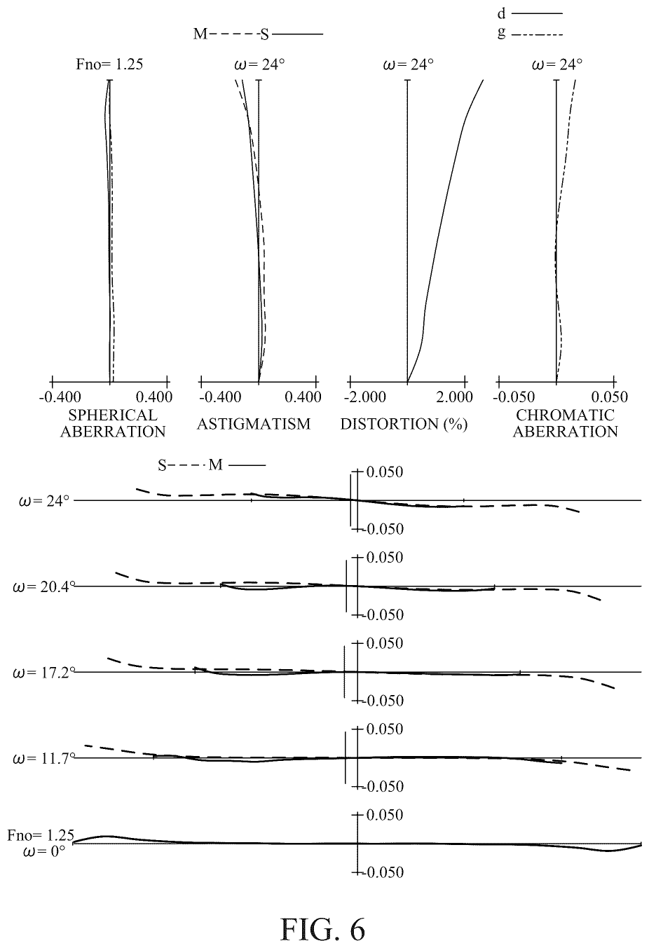

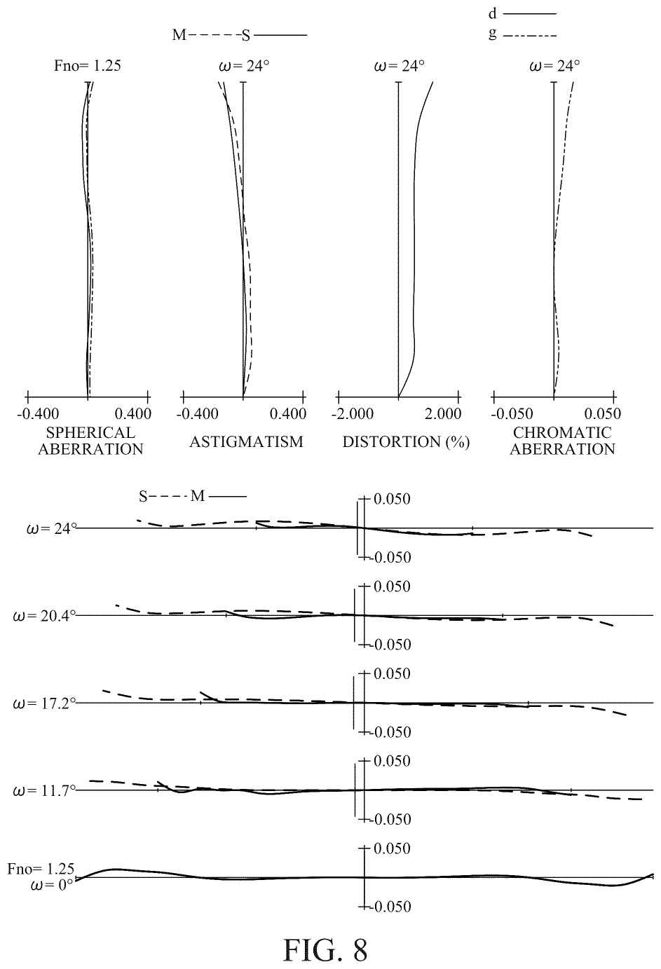

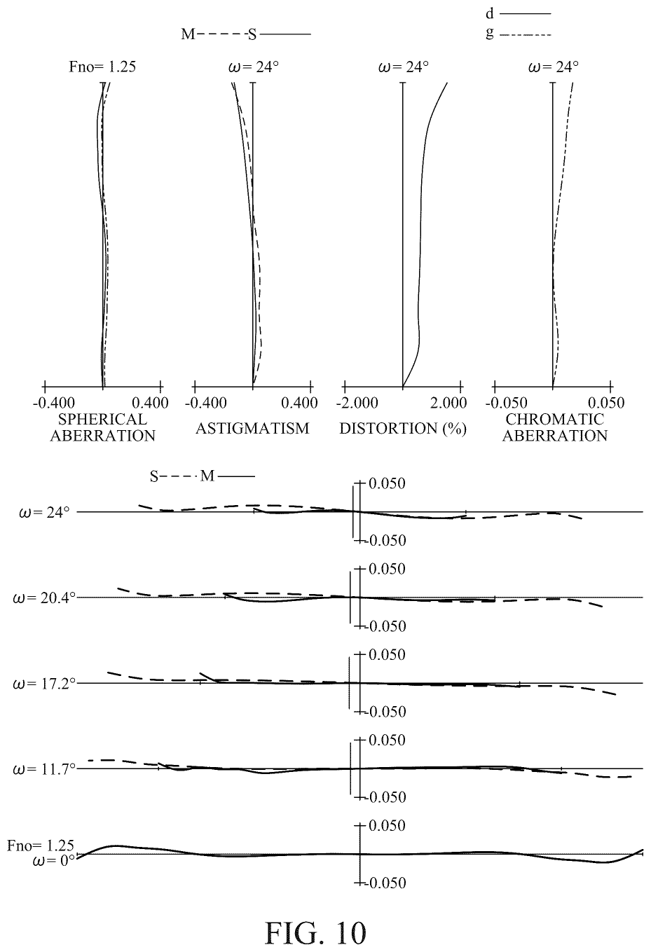

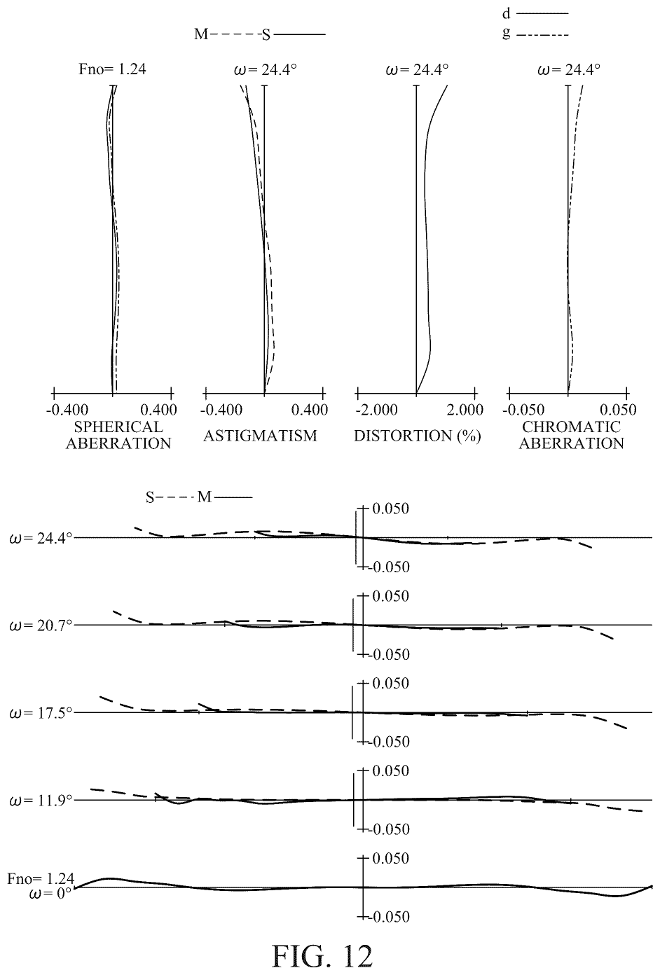

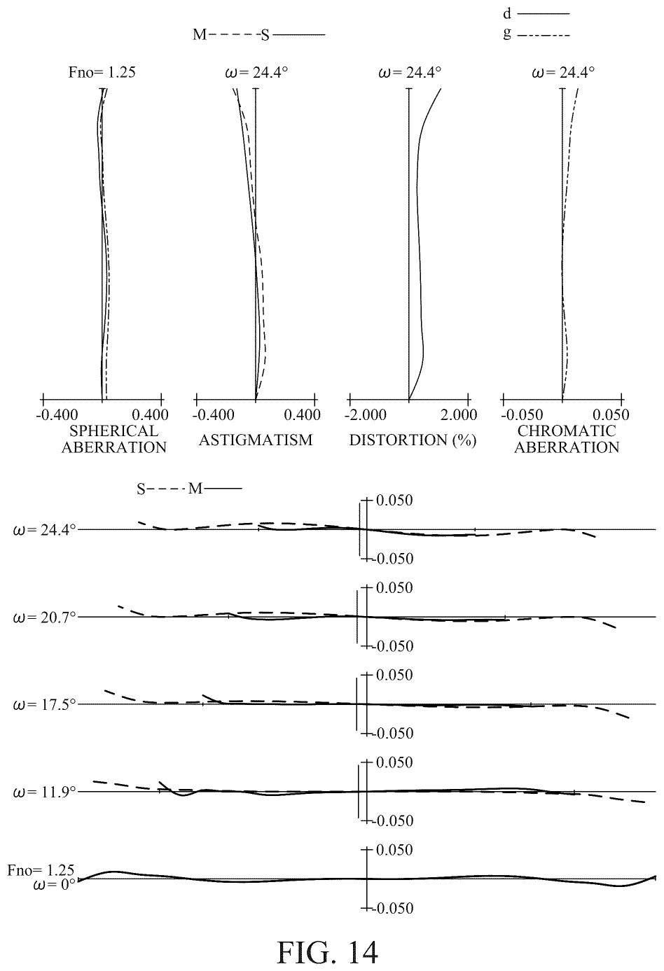

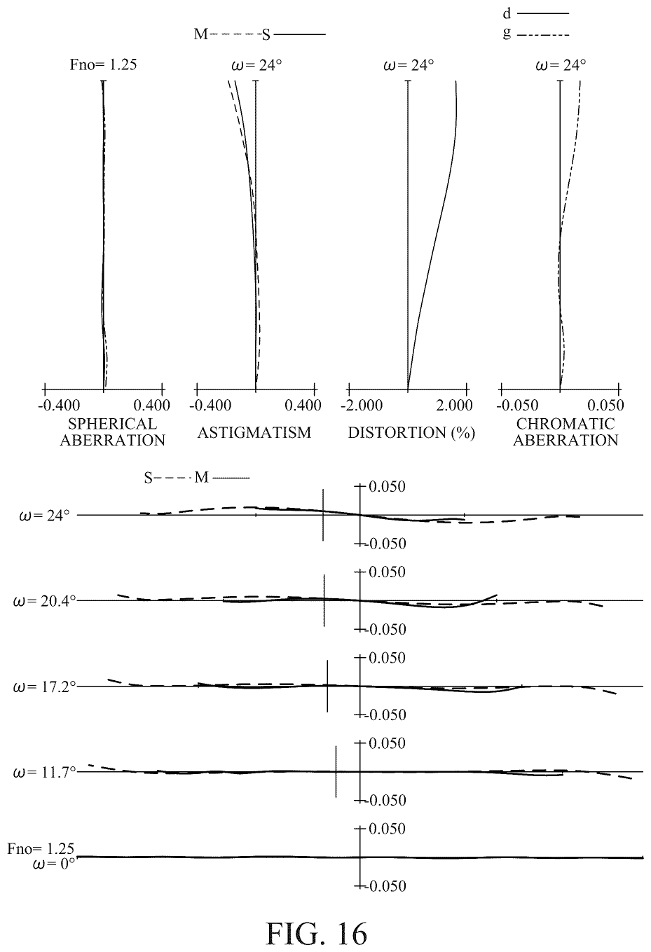

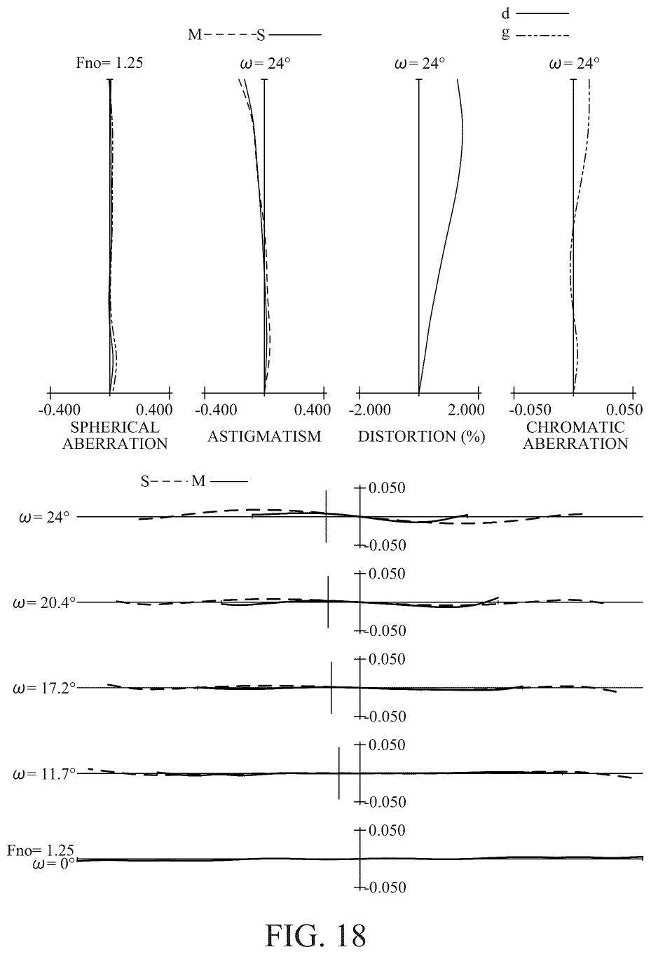

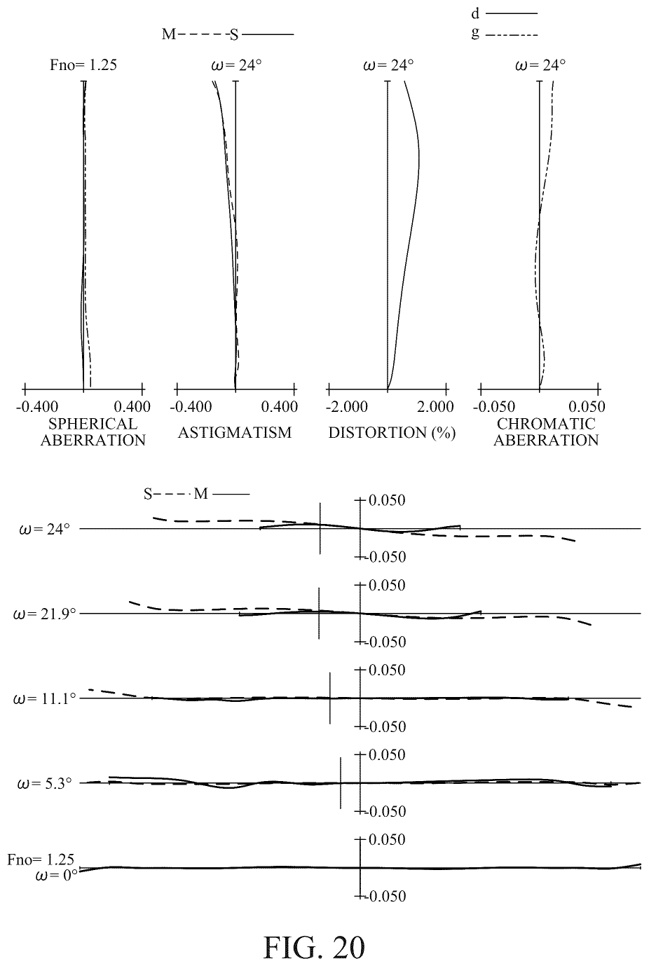

An asterisk “*” next to a surface number means that the surface has an aspheric shape. The aspheric shape is expressed by the following equation:

$$X = \frac{( 1 / R ) {H}^{2}}{1 + \sqrt{1 - ( 1 + K ) {( H / R )}^{2}}} + A 3 \times {\vert H \vert}^{3} + A 4 \times {\vert H \vert}^{4} + A 5 \times {\vert H \vert}^{5} + A 6 \times {\vert H \vert}^{6} + A 7 \times {\vert H \vert}^{7} + A 8 \times {\vert H \vert}^{8} + A 9 \times {\vert H \vert}^{9} + A 10 \times {\vert H \vert}^{10} + A 11 \times {\vert H \vert}^{11} + A 12 \times {\vert H \vert}^{12} + A 13 \times {\vert H \vert}^{13} + A 14 \times {\vert H \vert}^{14}$$

where X is a displacement amount from a surface vertex in the optical axis direction, His a height from the optical axis in a direction perpendicular to the optical axis, a light traveling direction is positive, R is a paraxial radius of curvature, K is a conic constant, and A3 to A14 are aspheric coefficients. The “e±x” in the conic constant and aspheric coefficients means “×10^{±x}” FIGS. 2, 4, 6, 8, 10, 12, 14, 16, 18 and 20 respectively illustrate the longitudinal aberrations (spherical aberration, astigmatism, distortion, and chromatic aberration) and lateral aberrations of the optical systems according to numerical examples 1 to 10 in an in-focus state at infinity. In the spherical aberration diagram, Fno represents an F-number. A solid line indicates a spherical aberration amount for the d-line, and an alternate long and two short dashes line indicates a spherical aberration amount for the g-line (with a wavelength of 435.8 nm). In the astigmatism diagram, a solid line S indicates an astigmatism amount on a sagittal image plane, and a dashed line M indicates an astigmatism amount on a meridional image plane. A distortion diagram illustrates a distortion amount for the d-line. A chromatic aberration diagram illustrates a lateral chromatic aberration for the g-line. ω is a half angle of view (°).

The lateral aberration diagram illustrates a lateral aberration amount for the d-line, a solid line M indicates a lateral aberration amount on the meridional section, and a dashed line S indicates a lateral aberration amount on the sagittal section.

### Numerical Example 1

UNIT: mm
SURFACE DATA

| | | | | | Effective |
|---|---|---|---|---|---|
| Surface No. | r | d | nd | νd | Diameter |
| 1 | −52.482 | 1.40 | 1.92286 | 20.9 | 38.96 |
| 2 | 108.023 | 4.86 | | | 41.65 |
| 3 | 181.785 | 7.77 | 1.95375 | 32.3 | 47.68 |
| 4 | −69.829 | 0.14 | | | 48.50 |
| 5 | 72.841 | 6.56 | 1.95906 | 17.5 | 50.00 |
| 6 | −743.568 | 0.20 | | | 49.53 |
| 7 | 134.931 | 11.26 | 1.71700 | 47.9 | 47.84 |
| 8 | −43.452 | 1.31 | 1.78880 | 28.4 | 46.66 |
| 9 | −117.176 | 0.10 | | | 44.15 |
| 10 | 226.380 | 5.10 | 1.43875 | 94.7 | 40.17 |
| 11 | −77.993 | 1.33 | 1.85478 | 24.8 | 38.59 |
| 12 | 83.028 | 3.86 | | | 35.67 |
| 13 | ∞ | (Variable) | | | 34.56 |
| (SP) | | | | | |
| 14 | −28.935 | 1.34 | 1.78880 | 28.4 | 29.20 |
| 15 | 27.835 | 10.19 | 2.00100 | 29.1 | 31.49 |
| 16 | −60.921 | 0.20 | | | 32.76 |
| 17* | 96.206 | 11.76 | 1.76385 | 48.5 | 34.02 |
| 18 | −24.110 | 2.02 | 1.84666 | 23.8 | 34.98 |
| 19 | −44.071 | (Variable) | | | 36.85 |
| 20* | −13.205 | 3.55 | 1.53500 | 56.0 | 36.20 |
| 21* | −12.550 | 3.37 | | | 34.67 |
| 22* | 56.432 | 4.06 | 1.63560 | 23.9 | 34.98 |
| 23* | 21.754 | 4.20 | | | 37.83 |
| 24 | −96.183 | 1.39 | 1.92286 | 20.9 | 38.00 |
| 25 | −96.519 | 38.50 | | | |
| Image Plane | ∞ | | | | |

ASPHERIC DATA
17th Surface
K = 0.00000e+00 A 4 = 5.37646e−05 A 6 = 1.55863e−06 A 8 = 6.05348e−09
A10 = 1.82198e−12
A 3 = −1.65820e−04 A 5 = −1.24402e−05 A 7 = −1.24659e−07 A 9 = −1.62280e−10
20th Surface
K = −4.27441e+00 A 4 = 1.78716e−05 A 6 = −6.05510e−06 A 8 = −2.51039e−08
A10 = −6.98524e−12
A 3 = 5.33362e−04 A 5 = 3.06426e−05 A 7 = 5.26407e−07 A 9 = 6.44512e−10
21st Surface
K = −4.40654e+00 A 4 = 6.44848e−04 A 6 = 9.25388e−06 A 8 = 2.81051e−08
A10 = 9.86621e−12
A 3 = −3.46691e−04 A 5 = −9.85179e−05 A 7 = −6.15848e−07 A 9 = −7.80055e−10
22nd Surface
K = 0.00000e+00 A 4 = 5.80061e−04 A 6 = 7.76706e−06 A 8 = −6.95980e−08
A10 = −1.91328e−10 A12 = −1.81766e−14
A 3 = −1.22295e−04 A 5 = −1.17096e−04 A 7 = 1.86177e−07 A 9 = 5.23501e−09
A11 = 3.30660e−12
23rd Surface
K = 0.00000e+00 A 4 = −2.19737e−04 A 6 = −1.00699e−05 A 8 = −1.69644e−07
A10 = −4.30350e−10 A12 = −9.61000e−14
A 3 = 7.95396e−04 A 5 = 3.69643e−05 A 7 = 1.67386e−06 A 9 = 1.08448e−08
A11 = 9.72341e−12

| | |
|---|---|
| Focal Length | 48.50 |
| Fno | 1.25 |
| Half Angle of View(°) | 24.04 |
| Image Height | 21.64 |
| Overall Lens Length | 113.00 |
| BF | 11.92 |

| Object Distance/ | | |
|---|---|---|
| Magnification | Infinity | 0.154-times |
| d13 | 13.27 | 7.22 |
| d19 | 1.84 | 7.88 |

| | |
|---|---|
| Entrance Pupil Position | 25.90 |
| Exit Pupil Position | −51.59 |
| Front Principal-Point Position | 37.37 |
| Rear Principal-Point Position | −36.58 |

LENS UNIT DATA

| | | Focal | | | |
|---|---|---|---|---|---|
| Lens | Starting | Lens | Configuration | Front Principal - | Rear Principal - |
| Unit | Surface | Length | Length | Point Position | Point Position |
| 1 | 1 | 76.33 | 43.88 | 13.83 | −10.43 |
| 2 | 14 | 40.71 | 25.52 | 14.32 | 2.58 |
| 3 | 20 | −85.30 | 16.57 | 4.32 | −8.00 |

### Numerical Example 2

UNIT: mm
SURFACE DATA

| | | | | | Effective |
|---|---|---|---|---|---|
| Surface No. | r | d | nd | νd | Diameter |
| 1 | −57.005 | 1.44 | 1.80810 | 22.8 | 38.96 |
| 2 | 90.515 | 5.96 | | | 41.28 |
| 3 | 97.899 | 8.21 | 1.94594 | 18.0 | 49.02 |
| 4 | −101.934 | 0.20 | | | 49.50 |
| 5 | 94.495 | 13.00 | 1.80400 | 46.5 | 49.39 |
| 6 | −45.449 | 1.40 | 1.92286 | 20.9 | 48.73 |
| 7 | −106.941 | 0.20 | | | 47.88 |
| 8 | 67.455 | 10.47 | 1.43875 | 94.7 | 42.80 |
| 9 | −48.750 | 1.40 | 1.58144 | 40.8 | 40.94 |
| 10 | 73.537 | 4.19 | | | 36.35 |
| 11 | ∞ | (Variable) | | | 35.23 |
| (SP) | | | | | |
| 12 | −32.143 | 1.39 | 1.74077 | 27.8 | 29.89 |
| 13 | 26.064 | 12.76 | 2.00100 | 29.1 | 31.39 |
| 14 | −75.863 | 0.20 | | | 31.13 |
| 15* | 89.351 | 11.05 | 1.69680 | 55.5 | 31.04 |
| 16 | −22.410 | 2.79 | 1.69895 | 30.1 | 31.97 |
| 17 | −51.399 | (Variable) | | | 33.67 |
| 18* | −13.515 | 3.76 | 1.53500 | 56.0 | 33.53 |
| 19* | −13.485 | 2.83 | | | 32.58 |
| 20* | 60.099 | 4.26 | 1.61550 | 25.8 | 33.16 |
| 21* | 21.080 | 3.13 | | | 36.83 |
| 22 | −240.533 | 2.28 | 2.00069 | 25.5 | 37.26 |
| 23 | −119.912 | | | | 37.80 |
| Image Plane | ∞ | | | | |

ASPHERIC DATA
15th Surface
K = 0.00000e+00 A 4 = 3.32972e−05 A 6 = 1.11752e−06 A 8 = 4.14369e−09
A10 = 1.04564e−12
A 3 = −1.00111e−04 A 5 = −8.89535e−06 A 7 = −8.84820e−08 A 9 = −1.04206e−10
18th Surface
K = −5.88757e+00 A 4 = −2.71472e−04 A 6 = −1.48622e−05 A 8 = −5.67023e−08
A10 = −1.61539e−11
A 3 = 7.95535e−04 A 5 = 9.96883e−05 A 7 = 1.20415e−06 A 9 = 1.46692e−09
19th Surface
K = −3.35640e+00 A 4 = 6.15817e−04 A 6 = 1.66019e−06 A 8 = −8.55019e−09
A10 = −5.05019e−14
A 3 = −1.43247e−04 A 5 = −6.16012e−05 A 7 = 1.05295e−07 A 9 = 1.76563e−10
20th Surface
K = 0.00000e+00 A 4 = 6.51831e−04 A 6 = 1.02975e−05 A 8 = −7.77252e−08
A10 = −3.25677e−10 A12 = −6.51157e−14
A 3 = −4.72892e−04 A 5 = −1.34367e−04 A 7 = 3.46845e−08 A 9 = 7.21992e−09
A11 = −7.39708e−12
21st Surface
K = 0.00000e+00 A 4 = −2.90800e−04 A 6 = −1.41705e−05 A 8 = −2.40217e−07
A10 = −6.85583e−10 A12 = −1.74180e−13
A 3 = 6.44304e−04 A 5 = 5.83963e−05 A 7 = 2.30041e−06 A 9 = 1.62058e−08
A11 = 1.65507e−11

| | |
|---|---|
| Focal Length | 48.50 |
| Fno | 1.25 |
| Half Angle of View(°) | 24.04 |
| Image Height | 21.64 |
| Overall Lens Length | 117.51 |
| BF | 11.92 |

| Object Distance/ | | |
|---|---|---|
| Magnification | Infinity | 0.156-times |
| d11 | 12.75 | 6.75 |
| d17 | 1.91 | 7.91 |

| | |
|---|---|
| Entrance Pupil Position | 27.93 |
| Exit Pupil Position | −54.47 |
| Front Principal-Point Position | 41.00 |
| Rear Principal-Point Position | −36.58 |

LENS UNIT DATA

| | | Focal | | | |
|---|---|---|---|---|---|
| Lens | Starting | Lens | Configuration | Front Principal - | Rear Principal - |
| Unit | Surface | Length | Length | Point Position | Point Position |
| 1 | 1 | 76.03 | 46.48 | 17.85 | −8.91 |
| 2 | 12 | 41.75 | 28.19 | 14.63 | 0.71 |
| 3 | 18 | −93.30 | 16.26 | 0.79 | −10.96 |

### Numerical Example 3

UNIT: mm
SURFACE DATA

| Surface No. | r | d | nd | νd | Effective Diameter |
|---|---|---|---|---|---|
| 1 | −57.655 | 1.44 | 1.80810 | 22.8 | 38.96 |
| 2 | 90.921 | 6.16 | | | 41.23 |
| 3 | 100.032 | 7.98 | 1.94594 | 18.0 | 49.04 |
| 4 | −104.726 | 0.20 | | | 49.50 |
| 5 | 96.854 | 12.67 | 1.80400 | 46.5 | 49.50 |
| 6 | −46.640 | 1.40 | 1.92286 | 20.9 | 48.90 |
| 7 | −105.961 | 0.20 | | | 48.14 |
| 8 | 65.321 | 10.84 | 1.43875 | 94.7 | 43.01 |
| 9 | −47.982 | 1.40 | 1.58144 | 40.8 | 41.08 |
| 10 | 72.990 | 4.20 | | | 36.46 |
| 11 (SP) | ∞ | (Variable) | | | 35.37 |
| 12 | −32.736 | 1.43 | 1.74077 | 27.8 | 29.98 |
| 13 | 26.135 | 12.01 | 2.00100 | 29.1 | 31.44 |
| 14 | −78.540 | 0.50 | | | 31.18 |
| 15* | 89.297 | 11.03 | 1.69680 | 55.5 | 31.05 |
| 16 | −22.527 | 2.44 | 1.69895 | 30.1 | 31.99 |
| 17 | −51.670 | (Variable) | | | 33.63 |
| 18* | −13.497 | 3.74 | 1.53500 | 56.0 | 33.52 |
| 19* | −13.289 | 2.82 | | | 32.56 |
| 20* | 62.834 | 4.43 | 1.61550 | 25.8 | 33.11 |
| 21* | 21.077 | 3.19 | | | 36.86 |
| 22 | −245.008 | 2.29 | 2.00069 | 25.5 | 37.26 |
| 23 | −117.939 | (Variable) | | | 37.80 |
| Image Plane | ∞ | | | | |

ASPHERICAL DATA
15th Surface
K = 0.00000e+00 A 4 = 3.33689e−05 A 6 = 1.12024e−06 A 8 = 4.13811e−09
A10 = 1.04675e−12
A 3 = −9.89037e−05 A 5 = −8.92891e−06 A 7 = −8.85418e−08 A 9 = −1.03939e−10
18th Surface
K = −5.59343e+00 A 4 = −2.48212e−04 A 6 = −1.44824e−05 A 8 = −5.60354e−08
A10 = −1.60139e−11
A 3 = 7.60344e−04 A 5 = 9.56402e−05 A 7 = 1.18371e−06 A 9 = 1.45357e−09
19th Surface
K = −3.18771e+00 A 4 = 6.12209e−04 A 6 = 1.74522e−06 A 8 = −7.07541e−09
A10 = 8.53125e−13
A 3 = −1.41291e−04 A 5 = −6.14094e−05 A 7 = 8.77888e−08 A 9 = 1.17866e−10
20th Surface
K = 0.00000e+00 A 4 = 6.38602e−04 A 6 = 9.77458e−06 A 8 = −7.78300e−08
A10 = −3.15421e−10 A12 = −6.15155e−14
A 3 = −4.51554e−04 A 5 = −1.30558e−04 A 7 = 6.85395e−08 A 9 = 7.07611e−09
A11 = 7.08707e−12
21st Surface
K = 0.00000e+00 A 4 = −2.90901e−04 A 6 = −1.42728e−05 A 8 = −2.38720e−07
A10 = −6.76314e−10 A12 = −1.71301e−13
A 3 = 6.33038e−04 A 5 = 5.91833e−05 A 7 = 2.29968e−06 A 9 = 1.60352e−08
A11 = 1.62948e−11

| | |
|---|---|
| Focal Length | 48.50 |
| Fno | 1.25 |
| Half Angle of View(°) | 24.04 |
| Image Height | 21.64 |
| Overall Lens Length | 117.18 |
| BF | 11.92 |

| Object Distance/Magnification | Infinity | 0.156-times |
|---|---|---|
| d11 | 12.99 | 6.69 |
| d17 | 1.90 | 7.98 |

| | |
|---|---|
| Entrance Pupil Position | 27.96 |
| Exit Pupil Position | −54.62 |
| Front Principal-Point Position | 41.11 |
| Rear Principal-Point Position | −36.58 |

LENS UNIT DATA

| Lens | Starting | Focal | Lens Configuration | Front Principal - | Rear Principal - |
|---|---|---|---|---|---|
| Unit | Surface | Length | Length | Point Position | Point Position |
| 1 | 1 | 76.81 | 46.48 | 18.00 | −8.82 |
| 2 | 12 | 42.39 | 27.41 | 14.35 | 0.58 |
| 3 | 18 | −96.89 | 16.48 | 0.87 | −11.04 |

### Numerical Example 4

UNIT: mm
SURFACE DATA

| Surface No. | r | d | nd | νd | Effective Diameter |
|---|---|---|---|---|---|
| 1 | −57.677 | 1.43 | 1.78472 | 25.7 | 39.40 |
| 2 | 84.118 | 6.81 | | | 41.25 |
| 3 | 95.377 | 8.63 | 1.92286 | 18.9 | 50.03 |
| 4 | −101.009 | 0.20 | | | 50.50 |
| 5 | 97.881 | 12.70 | 1.72916 | 54.7 | 50.26 |
| 6 | −48.085 | 1.38 | 1.92286 | 18.9 | 49.65 |
| 7 | −91.921 | 0.20 | | | 49.21 |
| 8 | 78.154 | 11.23 | 1.43875 | 94.7 | 44.03 |
| 9 | −43.858 | 1.41 | 1.56732 | 42.8 | 42.12 |
| 10 | 80.566 | 4.10 | | | 37.43 |
| 11 (SP) | ∞ | (Variable) | | | 36.39 |
| 12 | −30.774 | 1.45 | 1.74077 | 27.8 | 31.49 |
| 13 | 27.703 | 12.38 | 2.00100 | 29.1 | 34.07 |
| 14 | −75.431 | 0.20 | | | 33.99 |
| 15* | 72.163 | 12.61 | 1.64000 | 60.1 | 32.32 |
| 16 | −21.799 | 1.49 | 1.63980 | 34.5 | 33.34 |
| 17 | −47.877 | (Variable) | | | 34.89 |
| 18* | −16.619 | 3.96 | 1.53500 | 56.0 | 34.57 |
| 19* | −17.356 | 3.05 | | | 32.98 |
| 20* | 43.533 | 5.14 | 1.63560 | 23.9 | 33.38 |
| 21* | 21.080 | 4.00 | | | 36.60 |
| 22 | −113.628 | 2.42 | 1.95906 | 17.5 | 36.82 |
| 23 | −91.080 | | | | 37.63 |
| Image Plane | ∞ | | | | |

ASPHERIC DATA
15th Surface
K = 0.00000e+00 A 4 = 5.41546e−05 A 6 = 1.45093e−06 A 8 = 4.26187e−09
A10 = 7.39216e−13
A 3 = −1.76505e−04 A 5 = −1.24650e−05 A 7 = −1.03377e−07 A 9 = −9.14957e−11
18th Surface
K = −8.40074e+00 A 4 = −1.58789e−04 A 6 = −7.00442e−06 A 8 = −1.79131e−08
A10 = −2.32428e−12
A 3 = 7.86549e−04 A 5 = 5.33971e−05 A 7 = 4.78090e−07 A 9 = 3.38563e−10
19th Surface
K = −5.78545e+00 A 4 = 6.52084e−04 A 6 = 1.00083e−05 A 8 = 3.62759e−08
A10 = 1.40337e−11
A 3 = −3.20449e−04 A 5 = −1.00889e−04 A 7 = −7.25492e−07 A 9 = −1.07937e−09
20th Surface
K = 0.00000e+00 A 4 = 4.05205e−04 A 6 = 6.56796e−06 A 8 = −7.47369e−08
A10 = −3.30628e−10 A12 = −8.87165e−14
A 3 = −2.22625e−04 A 5 = −8.95434e−05 A 7 = 1.59019e−07 A 9 = 6.92079e−09
A11 = 8.35416e−12
21st Surface
K = 0.00000e+00 A 4 = −4.71817e−04 A 6 = −1.58142e−05 A 8 = −1.99245e−07
A10 = −5.19029e−10 A12 = −1.29054e−13
A 3 = 1.07100e−03 A 5 = 8.81324e−05 A 7 = 2.12198e−06 A 9 = 1.26705e−08
A11 = 1.23288e−11

| | |
|---|---|
| Focal Length | 48.50 |
| Fno | 1.25 |
| Half Angle of View(°) | 24.04 |
| Image Height | 21.64 |
| Overall Lens Length | 122.03 |
| BF | 11.99 |

| Object Distance/Magnification | Infinity | 0.156-times |
|---|---|---|
| d11 | 13.33 | 7.46 |
| d17 | 1.91 | 7.77 |

| | |
|---|---|
| Entrance Pupil Position | 28.24 |
| Exit Pupil Position | −54.31 |
| Front Principal-Point Position | 41.26 |
| Rear Principal-Point Position | −36.51 |

LENS UNIT DATA

| Lens | Starting | Focal | Lens Configuration | Front Principal - | Rear Principal - |
|---|---|---|---|---|---|
| Unit | Surface | Length | Length | Point Position | Point Position |
| 1 | 1 | 81.69 | 48.09 | 20.54 | −7.04 |
| 2 | 12 | 42.09 | 28.13 | 14.97 | 0.97 |
| 3 | 18 | −87.55 | 18.59 | 3.74 | −9.69 |

### Numerical Example 5

UNIT: mm
SURFACE DATA

| Surface No. | r | d | nd | νd | Effective Diameter |
|---|---|---|---|---|---|
| 1 | −57.108 | 1.44 | 1.78472 | 25.7 | 39.14 |
| 2 | 84.051 | 6.64 | | | 41.29 |
| 3 | 93.607 | 8.71 | 1.92286 | 18.9 | 50.03 |
| 4 | −100.238 | 0.20 | | | 50.50 |
| 5 | 97.808 | 12.90 | 1.72916 | 54.7 | 50.19 |
| 6 | −47.012 | 1.40 | 1.92286 | 18.9 | 49.56 |
| 7 | −90.310 | (Variable) | | | 49.10 |
| 8 | 93.968 | 10.78 | 1.43875 | 94.7 | 44.20 |
| 9 | −43.311 | 1.43 | 1.56732 | 42.8 | 42.41 |
| 10 | 102.979 | (Variable) | | | 38.05 |
| 11 (SP) | ∞ | (Variable) | | | 36.61 |
| 12 | −30.758 | 1.45 | 1.74077 | 27.8 | 31.46 |
| 13 | 27.429 | 12.62 | 2.00100 | 29.1 | 33.93 |
| 14 | −79.278 | 0.20 | | | 33.79 |
| 15* | 71.392 | 12.51 | 1.64000 | 60.1 | 32.22 |
| 16 | −21.821 | 1.65 | 1.63980 | 34.5 | 33.22 |
| 17 | −46.886 | (Variable) | | | 34.79 |
| 18* | −15.051 | 3.91 | 1.53500 | 56.0 | 34.44 |
| 19* | −15.900 | 3.00 | | | 32.81 |
| 20* | 43.280 | 5.32 | 1.63560 | 23.9 | 33.30 |
| 21* | 21.127 | 3.73 | | | 36.61 |
| 22 | −131.817 | 2.30 | 1.95906 | 17.5 | 36.84 |
| 23 | −106.190 | | | | 37.58 |
| Image Plane | ∞ | | | | |

ASPHERIC DATA
15th Surface
K = 0.00000e+00 A 4 = 5.74684e−05 A 6 = 1.51200e−06 A 8 = 4.35527e−09
A10 = 7.22714e−13
A 3 = −1.85812e−04 A 5 = −1.30857e−05 A 7 = −1.06798e−07 A 9 = −9.20134e−11
18th Surface
K = −7.08229e+00 A 4 = −1.68119e−04 A 6 = −8.97552e−06 A 8 = −2.78675e−08
A10 = −5.45973e−12
A 3 = 8.44342e−04 A 5 = 6.28773e−05 A 7 = 6.68687e−07 A 9 = 6.12342e−10
19th Surface
K = −4.64706e+00 A 4 = 7.60583e−04 A 6 = 1.02069e−05 A 8 = 3.24402e−08
A10 = 1.24833e−11
A 3 = −4.38725e−04 A 5 = −1.12557e−04 A 7 = −6.78666e−07 A 9 = −9.55775e−10
20th Surface
K = 0.00000e+00 A 4 = 5.18854e−04 A 6 = 8.60317e−06 A 8 = −7.51418e−08
A10 = −3.34287e−10 A12 = −8.49540e−14
A 3 = −4.04452e−04 A 5 = −1.11096e−04 A 7 = 7.12499e−08 A 9 = 7.09873e−09
A11 = 8.23498e−12
21st Surface
K = 0.00000e+00 A 4 = −4.61864e−04 A 6 = −1.56818e−05 A 8 = −1.99763e−07
A10 = −5.20986e−10 A12 = −1.28244e−13
A 3 = 1.04929e−03 A 5 = 8.66417e−05 A 7 = 2.11760e−06 A 9 = 1.27305e−08
A11 = 1.23271e−11

| | |
|---|---|
| Focal Length | 48.50 |
| Fno | 1.25 |
| Half Angle of View (°) | 24.04 |
| Image Height | 21.64 |
| Overall Lens Length | 122.18 |
| BF | 12.21 |

| Object Distance/Magnification | Infinity | 0.158-times |
|---|---|---|
| d7 | 0.20 | 0.78 |
| d10 | 4.29 | 3.71 |
| d11 | 13.36 | 7.54 |
| d17 | 1.91 | 7.74 |

| | |
|---|---|
| Entrance Pupil Position | 28.09 |
| Exit Pupil Position | −53.58 |
| Front Principal-Point Position | 40.84 |
| Rear Principal-Point Position | −36.28 |

LENS UNIT DATA

| Lens | Starting | Focal | Lens Configuration | Front Principal - | Rear Principal - |
|---|---|---|---|---|---|
| Unit | Surface | Length | Length | Point Position | Point Position |
| 1 | 1 | 64.06 | 31.30 | 24.03 | 9.68 |
| 2 | 8 | −285.48 | 12.21 | 19.60 | 10.46 |
| 3 | 12 | 42.34 | 28.42 | 15.26 | 1.20 |
| 4 | 18 | −84.85 | 18.26 | 3.75 | −9.24 |

### Numerical Example 6

UNIT: mm
SURFACE DATA

| Surface No. | r | d | nd | νd | Effective Diameter |
|---|---|---|---|---|---|
| 1 | −58.898 | 1.43 | 1.77830 | 23.9 | 38.97 |
| 2 | 79.559 | 7.50 | | | 40.39 |
| 3 | 87.680 | 8.91 | 1.92286 | 18.9 | 50.10 |
| 4 | −102.220 | 0.20 | | | 50.50 |
| 5 | 107.165 | 13.39 | 1.83481 | 42.7 | 49.86 |
| 6 | −42.832 | 1.41 | 1.92286 | 20.9 | 49.12 |
| 7 | −113.183 | 0.18 | | | 47.89 |
| 8 | 86.599 | 10.32 | 1.43875 | 94.7 | 43.18 |
| 9 | −44.859 | 1.41 | 1.62004 | 36.3 | 41.26 |
| 10 | 89.938 | 3.85 | | | 37.13 |
| 11 (SP) | ∞ | (Variable) | | | 36.10 |
| 12 | −30.631 | 1.44 | 1.74077 | 27.8 | 31.26 |
| 13 | 28.100 | 12.53 | 2.00100 | 29.1 | 33.80 |
| 14 | −72.348 | 0.20 | | | 33.75 |
| 15* | 73.399 | 12.66 | 1.61997 | 63.9 | 32.38 |
| 16 | −21.651 | 1.49 | 1.63980 | 34.5 | 33.39 |
| 17 | −45.432 | (Variable) | | | 35.07 |
| 18* | −22.765 | 4.76 | 1.58313 | 59.4 | 34.77 |
| 19* | −23.663 | 2.23 | | | 32.99 |
| 20* | 41.144 | 5.56 | 1.63560 | 23.9 | 33.26 |
| 21* | 21.025 | 3.97 | | | 36.50 |
| 22 | −106.173 | 2.31 | 2.00069 | 25.5 | 36.71 |
| 23 | −89.769 | | | | 37.52 |
| Image Plane | ∞ | | | | |

ASPHERIC DATA
15th Surface
K = 0.00000e+00 A 4 = 4.78352e−05 A 6 = 1.37566e−06 A 8 = 4.44487e−09
A10 = 9.60554e−13
A 3 = −1.57093e−04 A 5 = −1.14446e−05 A 7 = −1.02173e−07 A 9 = −1.03240e−10
18th Surface
K = −1.29274e+01 A 4 = −1.45405e−04 A 6 = −4.67476e−06 A 8 = −9.99426e−09
A10 = −9.34234e−13
A 3 = 6.80273e−04 A 5 = 4.00711e−05 A 7 = 2.91510e−07 A 9 = 1.68767e−10
19th Surface
K = −4.58640e+00 A 4 = 5.12047e−04 A 6 = 9.18831e−06 A 8 = 3.85546e−08
A10 = 1.55327e−11
A 3 = −2.27546e−05 A 5 = −8.37482e−05 A 7 = −7.29744e−07 A 9 = −1.17802e−09
20th Surface
K = 0.00000e+00 A 4 = 2.13459e−04 A 6 = 4.17605e−06 A 8 = −6.33667e−08
A10 = −2.82786e−10 A12 = −7.61168e−14
A 3 = 1.18437e−04 A 5 = −5.72546e−05 A 7 = 1.81175e−07 A 9 = 5.85598e−09
A11 = 7.19340e−12
21st Surface
K = 0.00000e+00 A 4 = −5.43258e−04 A 6 = −1.65813e−05 A 8 = −1.96156e−07
A10 = −5.22183e−10 A12 = −1.34334e−13
A 3 = 1.10691e−03 A 5 = 1.00494e−04 A 7 = 2.11678e−06 A 9 = 1.25576e−08
A11 = 1.26205e−11

| | |
|---|---|
| Focal Length | 47.62 |
| Fno | 1.25 |
| Half Angle of View(°) | 24.44 |
| Image Height | 21.64 |
| Overall Lens Length | 122.90 |
| BF | 11.99 |

| Object Distance/Magnification | Infinity | 0.156-times |
|---|---|---|
| d11 | 13.27 | 7.38 |
| d17 | 1.88 | 7.77 |

| | |
|---|---|
| Entrance Pupil Position | 27.70 |
| Exit Pupil Position | −54.18 |
| Front Principal-Point Position | 41.05 |
| Rear Principal-Point Position | −35.62 |

LENS UNIT DATA

| Lens | Starting | Focal | Lens Configuration | Front Principal - | Rear Principal - |
|---|---|---|---|---|---|
| Unit | Surface | Length | Length | Point Position | Point Position |
| 1 | 1 | 81.42 | 48.60 | 20.83 | −6.33 |
| 2 | 12 | 42.48 | 28.32 | 15.20 | 1.08 |
| 3 | 18 | −90.71 | 18.84 | 4.67 | −8.56 |

### Numerical Example 7

UNIT: mm
SURFACE DATA

| Surface No. | r | d | nd | νd | Effective Diameter |
|---|---|---|---|---|---|
| 1 | −59.271 | 1.45 | 1.77830 | 23.9 | 39.18 |
| 2 | 78.481 | 7.52 | | | 40.37 |
| 3 | 88.031 | 8.90 | 1.92286 | 18.9 | 50.10 |
| 4 | −101.866 | 0.20 | | | 50.50 |
| 5 | 106.241 | 13.37 | 1.83481 | 42.7 | 49.88 |
| 6 | −42.958 | 1.40 | 1.92286 | 20.9 | 49.16 |
| 7 | −113.119 | 0.18 | | | 47.93 |
| 8 | 83.478 | 10.39 | 1.43875 | 94.7 | 43.12 |
| 9 | −45.067 | 1.41 | 1.62004 | 36.3 | 41.17 |
| 10 | 84.082 | 3.95 | | | 36.95 |
| 11 (SP) | ∞ | (Variable) | | | 35.94 |
| 12 | −30.479 | 1.38 | 1.74077 | 27.8 | 31.30 |
| 13 | 28.090 | 12.57 | 2.00100 | 29.1 | 33.94 |
| 14 | −72.239 | 0.20 | | | 33.91 |
| 15* | 73.841 | 12.58 | 1.61997 | 63.9 | 32.26 |
| 16 | −21.658 | 1.44 | 1.63980 | 34.5 | 33.29 |
| 17 | −45.220 | (Variable) | | | 34.98 |
| 18* | −23.030 | 4.75 | 1.58313 | 59.4 | 34.73 |
| 19* | −23.797 | 2.22 | | | 32.97 |
| 20* | 39.989 | 5.42 | 1.63560 | 23.9 | 33.25 |
| 21* | 21.003 | (Variable) | | | 36.37 |
| 22 | −116.422 | 2.24 | 2.00069 | 25.5 | 36.83 |
| 23 | −99.610 | | | | 37.59 |
| Image Plane | ∞ | | | | |

ASPHERICAL DATA
15th Surface
K = 0.00000e+00 A 4 = 4.76767e−05 A 6 = 1.37160e−06 A 8 = 4.43564e−09
A10 = 9.58782e−13
A 3 = −1.56923e−04 A 5 = −1.14141e−05 A 7 = −1.01904e−07 A 9 = −1.03065e−10
18th Surface
K = −1.30224e+01 A 4 = −1.40575e−04 A 6 = −4.55413e−06 A 8 = −9.60966e−09
A10 = −8.15633e−13
A 3 = 6.77762e−04 A 5 = 3.90339e−05 A 7 = 2.82929e−07 A 9 = 1.58676e−10
19th Surface
K = −4.48730e+00 A 4 = 5.12069e−04 A 6 = 9.26009e−06 A 8 = 3.91727e−08
A10 = 1.58266e−11
A 3 = −2.10974e−05 A 5 = −8.39538e−05 A 7 = −7.39122e−07 A 9 = −1.19902e−09
20th Surface
K = 0.00000e+00 A 4 = 2.09225e−04 A 6 = 4.13181e−06 A 8 = −6.34547e−08
A10 = −2.82812e−10 A12 = −7.56848e−14
A 3 = 1.21537e−04 A 5 = −5.66474e−05 A 7 = 1.83081e−07 A 9 = 5.86021e−09
A11 = 7.18175e−12
21st Surface
K = 0.00000e+00 A 4 = −5.40859e−04 A 6 = −1.63457e−05 A 8 = −1.93607e−07
A10 = −5.17563e−10 A12 = −1.33696e−13
A 3 = 1.09739e−03 A 5 = 9.94067e−05 A 7 = 2.08612e−06 A 9 = 1.24198e−08
A11 = 1.25353e−11

| | |
|---|---|
| Focal Length | 47.60 |
| Fno | 1.25 |
| Half Angle of View(°) | 24.44 |
| Image Height | 21.64 |
| Overall Lens Length | 122.88 |
| BF | 12.09 |

| Object Distance/Magnification | Infinity | 0.155-times |
|---|---|---|
| d11 | 13.05 | 7.36 |
| d17 | 1.84 | 8.10 |
| d21 | 4.31 | 3.74 |

| | |
|---|---|
| Entrance Pupil Position | 27.88 |
| Exit Pupil Position | −54.12 |
| Front Principal-Point Position | 41.26 |
| Rear Principal-Point Position | −35.50 |

LENS UNIT DATA

| Lens | Starting | Focal | Lens Configuration | Front Principal - | Rear Principal - |
|---|---|---|---|---|---|
| Unit | Surface | Length | Length | Point Position | Point Position |
| 1 | 1 | 82.25 | 48.78 | 20.64 | −6.66 |
| 2 | 12 | 42.57 | 28.17 | 15.20 | 1.19 |
| 3 | 18 | −79.60 | 12.40 | 6.69 | −1.09 |
| 4 | 22 | 646.32 | 2.24 | 7.26 | 6.21 |

### Numerical Example 8

UNIT: mm
SURFACE DATA

| Surface No. | r | d | nd | νd | Effective Diameter |
|---|---|---|---|---|---|
| 1 | 1000.000 | 1.57 | 2.00100 | 29.1 | 38.96 |
| 2 | ∞ | 7.26 | | | 38.93 |
| 3 | −64.570 | 1.40 | 1.84666 | 23.8 | 38.76 |
| 4 | 82.506 | 7.08 | | | 40.59 |
| 5 | 132.751 | 6.79 | 1.91082 | 35.3 | 48.05 |
| 6 | −110.730 | 0.11 | | | 48.65 |
| 7 | 78.960 | 6.02 | 1.94594 | 18.0 | 50.00 |
| 8 | −1068.515 | 0.20 | | | 49.62 |
| 9 | 86.214 | 11.02 | 1.76385 | 48.5 | 47.73 |
| 10 | −52.439 | 1.27 | 1.85478 | 24.8 | 46.57 |
| 11 | −163.604 | 0.11 | | | 44.29 |
| 12 | 124.478 | 4.88 | 1.43875 | 94.7 | 40.24 |
| 13 | −122.423 | 1.29 | 1.85478 | 24.8 | 38.66 |
| 14 | 64.286 | 4.39 | | | 35.50 |
| 15 (SP) | ∞ | (Variable) | | | 34.34 |
| 16 | −27.994 | 1.29 | 1.78880 | 28.4 | 28.61 |
| 17 | 29.062 | 9.85 | 2.00100 | 29.1 | 31.19 |
| 18 | −53.658 | 0.20 | | | 32.29 |
| 19* | 94.813 | 11.85 | 1.76385 | 48.5 | 33.65 |
| 20 | −23.639 | 1.45 | 1.85478 | 24.8 | 34.56 |
| 21 | −45.440 | (Variable) | | | 36.28 |
| 22* | −14.039 | 3.99 | 1.58313 | 59.4 | 35.82 |
| 23* | −12.405 | 2.92 | | | 34.63 |
| 24* | 78.180 | 3.57 | 1.68948 | 31.0 | 34.95 |
| 25* | 21.567 | | | | 38.00 |
| Image Plane | ∞ | | | | |

ASPHERIC DATA
19th Surface
K = 0.00000e+00 A 4 = 6.32292e−05 A 6 = 2.21434e−06 A 8 = 9.48450e−09
A10 = 3.09432e−12
A 3 = −1.70963e−04 A 5 = −1.62090e−05 A 7 = −1.87106e−07 A 9 = −2.64337e−10
22nd Surface
K = −3.43065e+00 A 4 = 1.04387e−05 A 6 = −9.73401e−06 A 8 = −4.53649e−08
A10 = −1.34370e−11
A 3 = 4.90633e−04 A 5 = 4.68535e−05 A 7 = 9.01074e−07 A 9 = 1.21136e−09
23rd Surface
K = −3.86397e+00 A 4 = 8.03053e−04 A 6 = 1.33760e−05 A 8 = 4.37050e−08
A10 = 1.68143e−11
A 3 = −5.11667e−04 A 5 = −1.34444e−04 A 7 = −9.23043e−07 A 9 = −1.26929e−09
24th Surface
K = 0.00000e+00 A 4 = 7.88845e−04 A 6 = 1.55975e−05 A 8 = −1.88494e−08
A10 = −1.08563e−10 A12 = 1.94811e−15
A 3 = −2.01869e−04 A 5 = −1.72721e−04 A 7 = −5.58477e−07 A 9 = 2.77439e−09
A11 = 1.49300e−12
25th Surface
K = 0.00000e+00 A 4 = −2.37204e−04 A 6 = −1.29810e−05 A 8 = −2.21118e−07
A10 = −5.61060e−10 A12 = −1.26354e−13
A 3 = 8.53219e−04 A 5 = 4.46557e−05 A 7 = 2.18381e−06 A 9 = 1.41173e−08
A11 = 1.27265e−11

VARIOUS DATA

| | |
|---|---|
| Focal Length | 48.50 |
| Fno | 1.25 |
| Half Angle of View(°) | 24.04 |
| Image Height | 21.64 |
| Overall Lens Length | 120.00 |
| BF | 16.33 |

| Object Distance/Magnification | Infinity | 0.152-times |
|---|---|---|
| d15 | 13.30 | 7.38 |
| d21 | 1.84 | 7.77 |

| | |
|---|---|
| Entrance Pupil Position | 35.80 |
| Exit Pupil Position | −42.97 |
| Front Principal-Point Position | 44.63 |
| Rear Principal-Point Position | −32.17 |

LENS UNIT DATA

| Lens | Starting | Focal | Lens Configuration | Front Principal - | Rear Principal - |
|---|---|---|---|---|---|
| Unit | Surface | Length | Length | Point Position | Point Position |
| 1 | 1 | 74.00 | 53.40 | 22.83 | −11.03 |
| 2 | 16 | 39.93 | 24.64 | 13.63 | 2.24 |
| 3 | 22 | −76.12 | 10.48 | 4.27 | −2.45 |

### Numerical Example 9

UNIT: mm
SURFACE DATA

| Surface No. | r | d | nd | νd | Effective Diameter |
|---|---|---|---|---|---|
| 1 | 296.014 | 1.65 | 2.00100 | 29.1 | 38.96 |
| 2 | 419.137 | 7.26 | | | 38.86 |
| 3 | −64.808 | 1.46 | 1.84666 | 23.8 | 38.71 |
| 4 | 73.123 | 6.27 | | | 40.63 |
| 5 | 135.172 | 6.15 | 1.91082 | 35.3 | 47.36 |
| 6 | −129.521 | 0.16 | | | 48.02 |
| 7 | 97.022 | 6.19 | 1.94594 | 18.0 | 50.00 |
| 8 | −276.153 | 0.20 | | | 49.85 |
| 9 | 71.468 | 12.40 | 1.76385 | 48.5 | 47.95 |
| 10 | −49.479 | 1.39 | 1.85478 | 24.8 | 46.75 |
| 11 | −139.704 | 0.11 | | | 44.51 |
| 12 | 156.547 | 3.74 | 1.43875 | 94.7 | 40.52 |
| 13 | −239.478 | 1.41 | 1.85478 | 24.8 | 39.06 |
| 14 | 62.600 | (Variable) | | | 36.03 |
| 15 (SP) | ∞ | (Variable) | | | 34.82 |
| 16 | −30.050 | 1.45 | 1.78880 | 28.4 | 28.83 |
| 17 | 27.513 | 9.61 | 2.00100 | 29.1 | 30.45 |
| 18 | −69.975 | 0.20 | | | 31.92 |
| 19* | 95.890 | 11.65 | 1.76385 | 48.5 | 33.19 |
| 20 | −23.742 | 1.96 | 1.85478 | 24.8 | 34.25 |
| 21 | −43.249 | (Variable) | | | 36.18 |
| 22* | −14.678 | 3.92 | 1.58313 | 59.4 | 35.73 |
| 23* | −12.828 | 2.48 | | | 34.48 |
| 24* | 74.622 | 4.66 | 1.68948 | 31.0 | 34.60 |
| 25* | 21.555 | | | | 38.00 |
| Image Plane | ∞ | | | | |

ASPHERIC DATA
19th Surface
K = 0.00000e+00 A 4 = 6.03791e−05 A 6 = 2.21892e−06 A 8 = 9.65989e−09
A10 = 3.17596e−12
A 3 = −1.55004e−04 A 5 = −1.60217e−05 A 7 = −1.89413e−07 A 9 = −2.70138e−10
22nd Surface
K = −3.47418e+00 A 4 = 2.64139e−05 A 6 = −9.66133e−06 A 8 = −4.51978e−08
A10 = −1.34194e−11
A 3 = 4.15841e−04 A 5 = 4.56382e−05 A 7 = 8.97296e−07 A 9 = 1.20748e−09
23rd Surface
K = −4.22528e+00 A 4 = 8.07011e−04 A 6 = 1.37783e−05 A 8 = 4.44833e−08
A10 = 1.66680e−11
A 3 = −5.47883e−04 A 5 = −1.37042e−04 A 7 = −9.49537e−07 A 9 = −1.27441e−09
24th Surface
K = 0.00000e+00 A 4 = 7.63375e−04 A 6 = 1.45509e−05 A 8 = −1.86686e−08
A10 = −1.08001e−10 A12 = −8.56394e−16
A 3 = −4.19469e−04 A 5 = −1.61944e−04 A 7 = −5.17042e−07 A 9 = 2.70292e−09
A11 = 1.60470e−12
25th Surface
K = 0.00000e+00 A 4 = −2.55253e−04 A 6 = −1.37547e−05 A 8 = −2.19520e−07
A10 = −5.61626e−10 A12 = −1.27978e−13
A 3 = 5.92881e−04 A 5 = 5.44466e−05 A 7 = 2.19254e−06 A 9 = 1.40493e−08
A11 = 1.28176e−11

| | |
|---|---|
| Focal Length | 48.50 |
| Fno | 1.25 |
| Half Angle of View(°) | 24.04 |
| Image Height | 21.64 |
| Overall Lens Length | 120.00 |
| BF | 16.20 |

| Object Distance/Magnification | Infinity | 0.159-times |
|---|---|---|
| d14 | 4.54 | 7.09 |
| d15 | 13.02 | 7.05 |
| d21 | 1.94 | 7.90 |

| | |
|---|---|
| Entrance Pupil Position | 35.11 |
| Exit Pupil Position | −41.54 |
| Front Principal-Point Position | 42.87 |
| Rear Principal-Point Position | −32.30 |

LENS UNIT DATA

| Lens | Starting | Focal | Lens Configuration | Front Principal - | Rear Principal - |
|---|---|---|---|---|---|
| Unit | Surface | Length | Length | Point Position | Point Position |
| 1 | 1 | 71.61 | 48.37 | 23.57 | −5.40 |
| 2 | 16 | 42.90 | 24.87 | 14.34 | 2.82 |
| 3 | 22 | −80.40 | 11.06 | 5.49 | −1.41 |

### Numerical Example 10

UNIT: mm
SURFACE DATA

| Surface No. | r | d | nd | νd | Effective Diameter |
|---|---|---|---|---|---|
| 1 | −60.699 | 1.36 | 1.84666 | 23.8 | 38.96 |
| 2 | 82.970 | 6.43 | | | 41.15 |
| 3 | 2917.279 | 3.64 | 1.95375 | 32.3 | 46.06 |
| 4 | −141.895 | 0.15 | | | 46.94 |
| 5 | 78.186 | 8.96 | 1.84666 | 23.8 | 52.04 |
| 6 | −130.498 | 0.20 | | | 52.12 |
| 7 | 66.351 | 14.13 | 1.71700 | 47.9 | 50.02 |
| 8 | −48.476 | 1.29 | 1.78880 | 28.4 | 48.70 |
| 9 | −140.821 | 0.24 | | | 46.25 |
| 10 | 201.502 | 8.16 | 1.59282 | 68.6 | 42.39 |
| 11 | −45.384 | 1.33 | 1.72047 | 34.7 | 40.65 |
| 12 | 82.183 | 3.80 | | | 35.80 |
| 13 (SP) | ∞ | (Variable) | | | 34.49 |
| 14 | −33.003 | 1.32 | 1.78880 | 28.4 | 28.47 |
| 15 | 27.217 | 8.49 | 2.00100 | 29.1 | 29.86 |
| 16 | −101.028 | 0.20 | | | 30.93 |
| 17* | 96.420 | 10.76 | 1.76385 | 48.5 | 32.05 |
| 18 | −24.146 | 1.43 | 1.84666 | 23.8 | 33.30 |
| 19 | −39.274 | (Variable) | | | 34.94 |
| 20* | −16.083 | 4.48 | 1.53500 | 56.0 | 34.70 |
| 21* | −15.233 | 1.52 | | | 34.10 |
| 22* | 52.399 | 5.41 | 1.63560 | 23.9 | 34.28 |
| 23* | 21.359 | 2.78 | | | 37.93 |
| 24 | −508.103 | 1.31 | 1.92286 | 20.9 | 38.37 |
| 25 | 1609.712 | | | | 38.74 |
| Image Plane | ∞ | | | | |

APHERICAL DATA
17th Surface
K = 0.00000e+00 A 4 = 7.62821e−05 A 6 = 3.07168e−06 A 8 = 1.45215e−08
A10 = 5.06023e−12
A 3 = −1.86315e−04 A 5 = −2.10917e−05 A 7 = −2.74094e−07 A 9 = −4.18974e−10
20th Surface
K = −6.88013e+00 A 4 = −1.89303e−04 A 6 = −1.02530e−05 A 8 = −4.46873e−08
A10 = −1.37534e−11
A 3 = 6.85791e−04 A 5 = 6.61195e−05 A 7 = 8.87808e−07 A 9 = 1.21558e−09
21st Surface
K = −4.16417e+00 A 4 = 1.08906e−03 A 6 = 2.66900e−05 A 8 = 9.56578e−08
A10 = 3.41491e−11
A 3 = −5.97375e−04 A 5 = −2.26804e−04 A 7 = −1.99988e−06 A 9 = −2.69826e−09
22nd Surface
K = 0.00000e+00 A 4 = 7.37075e−04 A 6 = 2.16848e−05 A 8 = 2.96573e−08
A10 = −5.96693e−11 A12 = 1.67586e−14
A 3 = −3.44779e−04 A 5 = −1.89748e−04 A 7 = −1.29702e−06 A 9 = 8.64156e−10
A11 = 4.85021e−13
23rd Surface
K = 0.00000e+00 A 4 = −5.61961e−04 A 6 = −2.43268e−05 A 8 = −3.21277e−07
A10 = −8.07403e−10 A12 = −1.87901e−13
A 3 = 9.72704e−04 A 5 = 1.25282e−04 A 7 = 3.39021e−06 A 9 = 2.01933e−08
A11 = 1.85964e−11

| | |
|---|---|
| Focal Length | 48.50 |
| Fno | 1.25 |
| Half Angle of View(°) | 24.04 |
| Image Height | 21.64 |
| Overall Lens Length | 113.00 |
| BF | 10.71 |

| Object Distance/Magnification | Infinity | 0.159-times |
|---|---|---|
| d13 | 13.13 | 6.36 |
| d19 | 1.75 | 8.53 |

| | |
|---|---|
| Entrance Pupil Position | 29.34 |
| Exit Pupil Position | −39.71 |
| Front Principal-Point Position | 31.18 |
| Rear Principal-Point Position | −37.79 |

LENS UNIT DATA

| Lens | Starting | Focal | Lens Configuration | Front Principal - | Rear Principal - |
|---|---|---|---|---|---|
| Unit | Surface | Length | Length | Point Position | Point Position |
| 1 | 1 | 64.39 | 49.69 | 17.37 | −10.09 |
| 2 | 14 | 44.02 | 22.21 | 13.41 | 2.90 |
| 3 | 20 | −68.23 | 15.50 | 5.50 | −4.86 |

Table 1 summarizes values of inequalities (1) to (13) in numerical examples 1 to 10. Each numerical example satisfies all inequalities (1) to (13).

| | | Numerical Example | | | | | | | | | |
|---|---|---|---|---|---|---|---|---|---|---|---|
| | | 1 | 2 | 3 | 4 | 5 | 6 | 7 | 8 | 9 | 10 |
| Inequality | (1) | 5.22 | 5.43 | 5.42 | 5.64 | 5.65 | 5.68 | 5.68 | 5.55 | 5.55 | 5.22 |
| | (2) | 1.79 | 1.77 | 1.77 | 1.75 | 1.75 | 1.77 | 1.77 | 1.80 | 1.80 | 1.77 |
| | (3) | 0.11 | 0.10 | 0.10 | 0.10 | 0.10 | 0.10 | 0.10 | 0.14 | 0.14 | 0.09 |
| | (4) | 6.40 | 6.38 | 6.44 | 6.81 | 6.47 | 6.79 | 6.80 | 4.53 | 4.42 | 6.01 |
| | (5) | 0.48 | 0.45 | 0.44 | 0.48 | 0.50 | 0.47 | 0.46 | 0.52 | 0.53 | 0.65 |
| | (6) | 0.35 | 0.35 | 0.35 | 0.36 | 0.36 | 0.36 | 0.36 | 0.36 | 0.36 | 0.35 |
| | (7) | 0.89 | 0.81 | 0.79 | 0.93 | 0.93 | 0.90 | 0.89 | 0.97 | 0.89 | 0.94 |
| | (8) | 94.66 | 94.66 | 94.66 | 94.66 | 94.66 | 94.66 | 94.66 | 94.66 | 94.66 | 68.62 |
| | (9) | 17.47 | 17.98 | 17.98 | 18.90 | 18.90 | 18.90 | 18.90 | 17.98 | 17.98 | 23.78 |
| | (10) | 20.88 | 22.76 | 22.76 | 25.68 | 25.68 | 23.91 | 23.91 | 23.78 | 23.78 | 23.78 |
| | (11)Ra1 | 1.16 | 1.24 | 1.30 | 0.90 | 0.89 | 0.86 | 0.84 | 1.61 | 1.54 | 1.08 |
| | (11)Ra2 | 0.45 | 0.43 | 0.43 | 0.43 | 0.44 | 0.44 | 0.44 | 0.44 | 0.44 | 0.44 |
| | (12) | 1.6356 | 1.6155 | 1.6155 | 1.6356 | 1.6356 | 1.6356 | 1.6356 | 1.68948 | 1.68948 | 1.6356 |
| | (13)Rb1 | −0.27 | −0.28 | −0.28 | −0.34 | −0.31 | −0.48 | −0.48 | −0.29 | −0.30 | −0.33 |
| | (13)Rb2 | −0.26 | −0.28 | −0.27 | −0.36 | −0.33 | −0.50 | −0.50 | −0.26 | −0.26 | −0.31 |

### Image Pickup Apparatus

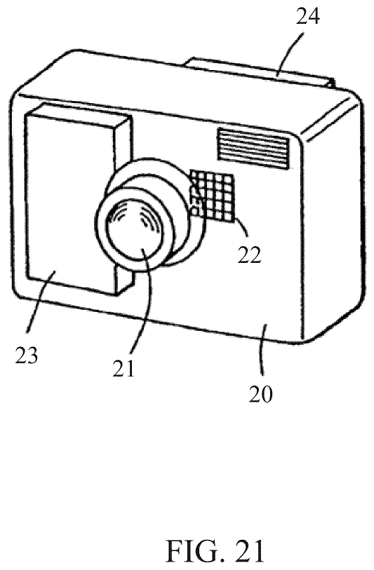

FIG. 21 illustrates a digital still camera as an image pickup apparatus using the optical system according to any one of Examples 1 to 10 as an imaging optical system. Reference numeral 20 denotes a camera body, and reference numeral 21 denotes an imaging optical system including any one of the optical systems according to Examples 1 to 10. Reference numeral 22 denotes a solid-state image sensor such as a CCD sensor or CMOS sensor that is built into the camera body 20 and captures an optical image (object image) formed by the imaging optical system 21. Reference numeral 23 denotes a recorder configured to record image data generated by processing an imaging signal from the image sensor 22. Reference numeral 24 denotes a rear display configured to display the image data.

The optical system according to each example used as an imaging optical system can provide a camera with a reduced size and high optical performance.

The camera may be a single-lens reflex camera with a quick-turn mirror, or a mirrorless camera having no quick-turn mirror. The camera may be a camera with an integrated lens.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide an optical system that has a large aperture diameter, a reduced size, and high optical performance, and can perform high-speed focusing.

This application claims priority to Japanese Patent Application No. 2024-012423, which was filed on Jan. 31, 2024, and Japanese Patent Application No. 2024-125583, which was filed on Aug. 1, 2024, and each of which is hereby incorporated by reference herein in its entirety.

What is claimed is:

1. An optical system comprising, in order from an object side to an image side:
a front group having positive refractive power and including at least one lens unit;
an intermediate lens unit having positive refractive power; and
a rear group having negative refractive power and including at least one lens unit,
wherein a distance between adjacent lens units changes during focusing,
wherein the intermediate lens unit moves toward the object side during focusing from infinity to a close distance,
wherein the front group includes at least two positive lenses and at least one negative lens, and
wherein the rear group includes at least one aspheric lens having an aspherical surface with a pole at a position separated from an optical axis.

2. The optical system according to claim 1, wherein the following inequality is satisfied:
$$3. 0 \leq TTL / ( f \times tan ω ) \leq 10.$$
where TTL is a distance on the optical axis from a lens surface closest to an object of the optical system to a lens surface closest to an image plane of the optical system plus an air equivalent length on the optical axis from the lens surface closest to the image plane of the optical system to the image plane, f is a focal length of the optical system, and ω is a half angle of view of the optical system.

3. The optical system according to claim 1, wherein the following inequality is satisfied:
$$1. 50 \leq PNdave \leq 2.$$
where PNdave is an average of refractive indices for d-line of all positive lenses included in the optical system.

4. The optical system according to claim 1, wherein the following inequality is satisfied:
$$0.01 \leq sk / TTL \leq 0.50$$
where TTL is a distance on the optical axis from a lens surface closest to an object of the optical system to a lens surface closest to an image plane of the optical system plus an air equivalent length on the optical axis from the lens surface closest to the image plane of the optical system to the image plane, and sk is the air equivalent length.

5. The optical system according to claim 1, wherein the following inequality is satisfied:
$$2. \leq ff / sk \leq 10.0$$
where ff is a focal length of the front group, and sk is an air equivalent length on the optical axis from a lens surface closest to an image plane of the optical system to the image plane.

6. The optical system according to claim 1, wherein the following inequality is satisfied:
$$0.1 \leq - fm / fr \leq 1.$$
where fm is a focal length of the intermediate lens unit, and fr is a focal length of the rear group.

7. The optical system according to claim 1, wherein the following inequality is satisfied:
$$0.1 \leq Df / f \leq 1.$$
where Df is a distance on the optical axis between the front group and the intermediate lens unit, and f is a focal length of the optical system.

8. The optical system according to claim 1, wherein the following inequality is satisfied:
$$0.1 \leq - ff / fr \leq 2.0$$
where ff is a focal length of the front group, and fr is a focal length of the rear group.

9. The optical system according to claim 1, wherein the following inequality is satisfied:
$$55 \leq vdp 1 \leq 96$$
where vdp1 is an Abbe number of a positive lens having the largest Abbe number based on d-line among all positive lenses included in the front group.

10. The optical system according to claim 1, wherein the following inequality is satisfied:
$$15 \leq vdp 2 \leq 40$$
where vdp2 is an Abbe number of a positive lens having the smallest Abbe number based on d-line among all positive lenses included in the front group.

11. The optical system according to claim 1, wherein the following inequality is satisfied:
$$15 \leq vdn \leq 40$$
where vdn is an Abbe number of a negative lens disposed closest to an object among all negative lenses included in the front group.

12. The optical system according to claim 11, wherein the negative lens disposed closest to the object among all the negative lenses included in the front group has a biconcave shape.

13. The optical system according to claim 1, wherein the following inequalities are satisfied:
$$0 < Ra 1 / f$$
$$0 < Ra 2 / f$$
where Ra1 and Ra2 are paraxial radii of curvature of object-side and image-side lens surfaces of an aspheric lens included in the at least one aspheric lens, respectively, and f is a focal length of the optical system.

14. The optical system according to claim 1, wherein the following inequalities are satisfied:
$$1.44 \leq Nda \leq 1.77$$
where Nda is a refractive index for d-line of the at least one aspheric lens.

15. The optical system according to claim 13, wherein the at least one aspheric lens includes an aspheric lens that satisfies the inequalities:
$$Rb 1 / f < 0$$
$$Rb 2 / f < 0$$
where Rb1 and Rb2 are paraxial radii of curvature of object-side and image-side lens surfaces, respectively.

16. An optical system comprising, in order from an object side to an image side:
a front group having positive refractive power;
an intermediate lens unit; and
a rear group including at least one lens unit,
wherein a distance between adjacent lens units changes during focusing,
wherein the intermediate lens unit moves toward the object side during focusing from infinity to a close distance,
wherein the front group includes at least two positive lenses and at least one negative lens, and
wherein the rear group includes at least one aspheric lens having an aspherical surface with a pole at a position separated from an optical axis.

17. An image pickup apparatus comprising:
the optical system according to claim 1; and
an image sensor configured to image an object through the optical system.

18. An image pickup apparatus comprising:
the optical system according to claim 16; and
an image sensor configured to image an object through the optical system.
